(19) United States
(12) Patent Application Publication
(10) Pub. No.: US 2019/0357295 A1
(43) Pub. Date: Nov. 21, 2019

(54) METHOD FOR TRANSMITTING AND RECEIVING NAS MESSAGE IN WIRELESS COMMUNICATION SYSTEM AND APPARATUS FOR SAME

(71) Applicant: LG ELECTRONICS INC., Seoul (KR)

(72) Inventors: Taehun KIM, (US); Daewook BYUN, (US); Jaehyun KIM, (US)

(21) Appl. No.: 16/484,781

(22) PCT Filed: Feb. 12, 2018
(86) PCT No.: PCT/KR2018/001821

§ 371 Date: Aug. 8, 2019

Related U.S. Application Data
(60) Provisional application No. 62/457,186, filed on Feb. 10, 2017.
(60) Provisional application No. 62/458,989, filed on Feb. 14, 2017.

(51) Int. Cl. H04W 76/25; H04W 68/00; H04L 5/00; H04W 76/27

(52) U.S. Cl. CPC H04W 76/25; H04W 76/27; H04L 5/0055; H04W 68/005

(57) ABSTRACT

Disclosed herein is a method for transmitting and receiving a NAS message in a wireless communication system and an apparatus for the same. Particularly, a method for transmitting a Non-Access Stratum (NAS) message to a User Equipment (UE) in a wireless communication system may include receiving, by a base station, an indication for a transmission of a downlink NAS message from a Core Network (CN) node; initiating, by the base station, a transmission of paging to the UE, when a connection related to the UE is maintained between the base station and the CN node, but the UE is in a state in which a connection is related from the base station; and transmitting, by the base station, an Acknowledgement (ACK) indication to the CN node in response to the indication after the paging transmission is initiated.

### CROSS-REFERENCE TO RELATED APPLICATION

This application is the National Stage filing under 35 U.S.C. 371 of International Application No. PCT/KR2018/001821, filed on Feb. 12, 2018, which claims the benefit of U.S. Provisional Application No. 62/457186, filed on Feb. 10, 2017, No. 62/458989, filed on Feb. 14, 2017, the contents of which are all hereby incorporated by reference herein in their entirety.

### BACKGROUND OF THE INVENTION

### Field of the Invention

The present invention relates to a wireless communication system and, more particularly, to a method for transmitting and receiving a Non-Access Stratum (NAS) message and an apparatus for supporting the same.

### Related Art

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### SUMMARY OF THE INVENTION

An object of the present invention is to provide a method for transmitting and receiving a Non-Access Stratum (NAS) message to/from a User Equipment (UE) which is in a light connection state or a Radio Resource Control (RRC)-Inactive state.

Technical objects to be achieved in the present invention are not limited to the above-described technical objects, and other technical objects not described above may be evidently understood by a person having ordinary skill in the art to which the present invention pertains from the following description.

In an aspect of the present invention, a method for transmitting a Non-Access Stratum (NAS) message to a User Equipment (UE) in a wireless communication system may include receiving, by a base station, an indication for a transmission of a downlink NAS message from a Core Network (CN) node, initiating, by the base station, a transmission of paging to the UE, when a connection related to the UE is maintained between the base station and the CN node, but the UE is in a state in which a connection is related from the base station, and transmitting, by the base station, an Acknowledgement (ACK) indication to the CN node in response to the indication after the paging transmission is initiated.

Preferably, the method may further include receiving, by the base station, an RRC Connection Resume Request message for requesting Radio Resource Control (RRC) connection establishment from the UE in response to the paging; and transmitting, by the base station, an RRC Connection Resume Request message in response to the RRC Connection Resume Request message, when the base station accepts the RRC connection establishment.

Preferably, the method may further include transmitting, by the base station, an RRC message including the downlink NAS message to the UE after the RRC connection establishment is completed, when the base station receives the downlink NAS message together with the indication.

Preferably, the method may further include transmitting, by the base station, the downlink NAS message to the CN node, when the base station receives the RRC message including an uplink NAS message, which is a response to the downlink NAS message from the UE.

Preferably, the method may further include transmitting, by the base station, an indication for the RRC connection establishment to the CN node, when the RRC connection establishment is completed; and transmitting, by the base station, an RRC message including the downlink NAS message to the UE, when the base station receives the downlink NAS message from the CN node.

Preferably, the method may further include transmitting, by the base station, an indication or cause for informing a failure of the paging transmission to the CN node, when the paging transmission is failed.

In another aspect of the present invention, a method for transmitting a Non-Access Stratum (NAS) message to a User Equipment (UE) in a wireless communication system may include transmitting, by a Core Network (CN) node, an indication for a transmission of a downlink NAS message to a base station, and staring a first timer when transmitting the indication; and stopping, by the CN node, the first timer when the CN node receives an Acknowledgement (ACK) indication from the base station in response to the indication, and a connection related to the UE is maintained between the base station and the CN node, but the UE is in a state in which a connection is related from the base station.

Preferably, the downlink NAS message may be transmitted together with the indication or transmitted after receiving an indication for a Radio Resource Control (RRC) connection from the base station.

Preferably, the method may further include starting a second timer, when the ACK indication is received.

Preferably, the method may further include stopping the second timer when an uplink NAS message is received from the UE, which is a response to the downlink NAS message.

Preferably, the method may further include stopping the second timer, when an indication for a Radio Resource Control (RRC) connection establishment is received from the base station.

Preferably, the method may further include stopping the second timer, when an indication or cause for informing a failure of the paging transmission.

Preferably, the method may further include switching, by the CN node, to an IDLE mode or retransmitting the indication to the base station.

Preferably, the method may further include switching, by the CN node, to an IDLE mode or retransmitting the downlink NAS message and the indication to the base station, when any response is received from the base station until the second timer expires.

According to the present invention, a NAS message may be transmitted and received stably to/from a UE which is in a light connection state or an RRC-Inactive state.

In addition, according to the present invention, a retransmission and reception due to a transmission and reception failure of a NAS message to/from a UE which is in a light connection state or an RRC-Inactive state.

In addition, according to the present invention, unnecessary signaling for transmitting and receiving a NAS message to/from a UE which is in a light connection state or an RRC-Inactive state.

The effects which may be obtained in the present invention are not limited to the above-described effects, and other technical effects not described above may be evidently understood by a person having ordinary skill in the art to which the present invention pertains from the following description.

### BRIEF DESCRIPTION OF THE DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a diagram schematically exemplifying an evolved packet system (EPS) to which the present invention can be applied.

FIG. 2 illustrates an example of evolved universal terrestrial radio access network structure to which the present invention can be applied.

FIG. 3 exemplifies a structure of E-UTRAN and EPC in a wireless communication system to which the present invention can be applied.

FIG. 4 illustrates a structure of a radio interface protocol between a UE and E-UTRAN in a wireless communication system to which the present invention can be applied.

FIG. 5 is a diagram schematically showing a structure of a physical channel in a wireless communication system to which the present invention may be applied.

FIG. 6 is a diagram for describing a contention based random access procedure in a wireless communication system to which the present invention may be applied.

FIG. 7 is a diagram illustrating NAS non-delivery indication procedure in a wireless communication system to which the present invention may be applied.

FIG. 8 is a diagram illustrating a 5G system to which the present invention may be applied.

FIG. 9 illustrates a state mode in a wireless communication system to which the present invention may be applied.

FIG. 10 is a diagram illustrating a method for transmitting and receiving downlink NAS message according to an embodiment of the present invention.

FIG. 11 is a diagram illustrating a method for transmitting and receiving DL NAS message according to an embodiment of the present invention.

FIG. 12 is a diagram illustrating a method for transmitting and receiving DL NAS message according to an embodiment of the present invention.

FIG. 13 is a diagram illustrating a method for transmitting and receiving DL NAS message according to an embodiment of the present invention.

FIG. 14 is a diagram illustrating a method for transmitting and receiving UL NAS message according to an embodiment of the present invention.

FIG. 15 is a diagram illustrating a method for transmitting and receiving NAS message according to an embodiment of the present invention.

FIG. 16 illustrates a block diagram of a communication apparatus according to an embodiment of the present invention.

FIG. 17 illustrates a block diagram of a wireless communication apparatus according to an embodiment of the present invention.

### DESCRIPTION OF EXEMPLARY EMBODIMENTS

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention may be embodied without the specific information.

For some cases, to avoid obscuring the technical principles of the present invention, structures and devices well-known to the public may be omitted or may be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE may be performed by the base station or by network nodes other than the base station. The term Base Station (BS) may be replaced with a fixed station, Node B, evolved-NodeB (eNB), Base Transceiver System (BTS), or Access Point (AP). Also, a terminal may be fixed or mobile; and the term may be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter may be part of the base station, and a receiver may be part of the terminal. Similarly, in uplink transmission, a transmitter may be part of the terminal, and a receiver may be part of the base station.

Specific terms used in the following descriptions are introduced to help understanding the present invention, and the specific terms may be used in different ways as long as it does not leave the technical scope of the present invention.

The technology described below may be used for various types of wireless access systems based on Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), or Non-Orthogonal Multiple Access (NOMA). CDMA may be implemented by such radio technology as Universal Terrestrial Radio Access (UTRA) or CDMA2000. TDMA may be implemented by such radio technology as Global System for Mobile communications (GSM), General Packet Radio Service (GPRS), or Enhanced Data rates for GSM Evolution (EDGE). OFDMA may be implemented by such radio technology as the IEEE 802.11 (Wi-Fi), the IEEE 802.16 (WiMAX), the IEEE 802-20, or Evolved UTRA (E-UTRA). UTRA is part of the Universal Mobile Telecommunications System (UMTS). The 3rd Generation Partnership Project (3GPP) Long Term Evolution (LTE) is part of the Evolved UMTS (E-UMTS) which uses the E-UTRA, employing OFDMA for downlink and SC-FDMA for uplink transmission. The LTE-A (Advanced) is an evolved version of the 3GPP LTE system.

Embodiments of the present invention may be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention may be supported by the documents above. Also, all of the terms disclosed in this document may be explained with reference to the standard documents.

To clarify the descriptions, this document is based on the 3GPP LTE/LTE-A, but the technical features of the present invention are not limited to the current descriptions.

Terms used in this document are defined as follows.

Universal Mobile Telecommunication System (UMTS): the 3rd generation mobile communication technology based on GSM, developed by the 3GPP

Evolved Packet System (EPS): a network system comprising an Evolved Packet Core (EPC), a packet switched core network based on the Internet Protocol (IP) and an access network such as the LTE and UTRAN. The EPS is a network evolved from the UMTS.

NodeB: the base station of the UMTS network. NodeB is installed outside and provides coverage of a macro cell.

eNodeB: the base station of the EPS network. eNodeB is installed outside and provides coverage of a macro cell.

User Equipment (UE): A UE may be called a terminal, Mobile Equipment (ME), or Mobile Station (MS). A UE may be a portable device such as a notebook computer, mobile phone, Personal Digital Assistant (PDA), smart phone, or a multimedia device; or a fixed device such as a Personal Computer (PC) or vehicle-mounted device. The term UE may refer to an MTC terminal in the description related to MTC.

IP Multimedia Subsystem (IMS): a sub-system providing multimedia services based on the IP

International Mobile Subscriber Identity (IMSI): a globally unique subscriber identifier assigned in a mobile communication network

Machine Type Communication (MTC): communication performed by machines without human intervention. It may be called Machine-to-Machine (M2M) communication.

MTC terminal (MTC UE or MTC device): a terminal (for example, a vending machine, meter, and so on) equipped with a communication function operating through a mobile communication network(For example, communicating with an MTC server via a PLMN) and performing an MTC function

MTC server: a server on a network managing MTC terminals. It may be installed inside or outside a mobile communication network. It may provide an interface through which an MTC user may access the server. Also, an MTC server may provide MTC-related services to other servers (in the form of Services Capability Server (SCS)) or the MTC server itself may be an MTC Application Server.

(MTC) application: services (to which MTC is applied) (for example, remote metering, traffic movement tracking, weather observation sensors, and so on)

(MTC) Application Server: a server on a network in which (MTC) applications are performed

MTC feature: a function of a network to support MTC applications. For example, MTC monitoring is a feature intended to prepare for loss of a device in an MTC application such as remote metering, and low mobility is a feature intended for an MTC application with respect to an MTC terminal such as a vending machine.

MTC User (MTC User): The MTC user uses the service provided by the MTC server.

MTC subscriber: an entity having a connection relationship with a network operator and providing services to one or more MTC terminals.

MTC group: an MTC group shares at least one or more MTC features and denotes a group of MTC terminals belonging to MTC subscribers.

Services Capability Server (SCS): an entity being connected to the 3GPP network and used for communicating with an MTC InterWorking Function (MTC-IWF) on a Home PLMN (HPLMN) and an MTC terminal. The SCS provides the capability for use by one or more MTC applications.

External identifier: a globally unique identifier used by an external entity (for example, an SCS or an Application Server) of the 3GPP network to indicate (or identify) an MTC terminal (or a subscriber to which the MTC terminal belongs). An external identifier includes a domain identifier and a local identifier as described below.

Domain identifier: an identifier used for identifying a domain in the control region of a mobile communication network service provider. A service provider may use a separate domain identifier for each service to provide an access to a different service.

Local identifier: an identifier used for deriving or obtaining an International Mobile Subscriber Identity (IMSI). A local identifier should be unique within an application domain and is managed by a mobile communication network service provider.

Radio Access Network (RAN): a unit including a Node B, a Radio Network Controller (RNC) controlling the Node B, and an eNodeB in the 3GPP network. The RAN is defined at the terminal level and provides a connection to a core network.

Home Location Register (HLR)/Home Subscriber Server (HSS): a database provisioning subscriber information within the 3GPP network. An HSS may perform functions of configuration storage, identity management, user state storage, and so on.

RAN Application Part (RANAP): an interface between the RAN and a node in charge of controlling a core network (in other words, a Mobility Management Entity (MME)/Serving GPRS (General Packet Radio Service) Supporting Node (SGSN)/Mobile Switching Center (MSC)).

Public Land Mobile Network (PLMN): a network formed to provide mobile communication services to individuals. The PLMN may be formed separately for each operator.

Service Capability Exposure Function (SCEF): An entity within the 3GPP architecture for service capability exposure that provides a means for securely exposing services and capabilities provided by 3GPP network interfaces.

In what follows, the present invention will be described based on the terms defined above.

Overview of System to Which the Present Invention May be Applied

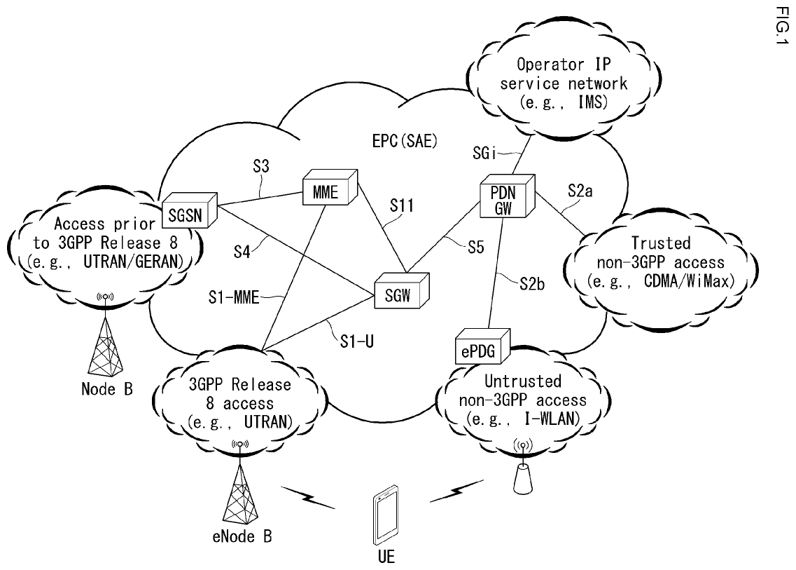

FIG. 1 illustrates an Evolved Packet System (EPS) to which the present invention may be applied.

The network structure of FIG. 1 is a simplified diagram restructured from an Evolved Packet System (EPS) including Evolved Packet Core (EPC).

The EPC is a main component of the System Architecture Evolution (SAE) intended for improving performance of the 3GPP technologies. SAE is a research project for determining a network structure supporting mobility between multiple heterogeneous networks. For example, SAE is intended to provide an optimized packet-based system which supports various IP-based wireless access technologies, provides much more improved data transmission capability, and so on.

More specifically, the EPC is the core network of an IP-based mobile communication system for the 3GPP LTE system and capable of supporting packet-based real-time and non-real time services. In the existing mobile communication systems (namely, in the 2nd or 3rd mobile communication system), functions of the core network have been implemented through two separate sub-domains: a Circuit-Switched (CS) sub-domain for voice and a Packet-Switched (PS) sub-domain for data. However, in the 3GPP LTE system, an evolution from the 3rd mobile communication system, the CS and PS sub-domains have been unified into a single IP domain. In other words, in the 3GPP LTE system, connection between UEs having IP capabilities may be established through an IP-based base station (for example, eNodeB), EPC, and application domain (for example, IMS). In other words, the EPC provides the architecture essential for implementing end-to-end IP services.

The EPC includes various components, where FIG. 1 illustrates part of the EPC components, including a Serving Gateway (SGW or S-GW), Packet Data Network Gateway (PDN GW or PGW or P-GW), Mobility Management Entity (MME), Serving GPRS Supporting Node (SGSN), and enhanced Packet Data Gateway (ePDG).

The SGW operates as a boundary point between the Radio Access Network (RAN) and the core network and maintains a data path between the eNodeB and the PDN GW. Also, if UE moves across serving areas by the eNodeB, the SGW acts as an anchor point for local mobility. In other words, packets may be routed through the SGW to ensure mobility within the E-UTRAN (Evolved-UMTS (Universal Mobile Telecommunications System) Terrestrial Radio Access Network defined for the subsequent versions of the 3GPP release 8). Also, the SGW may act as an anchor point for mobility between the E-UTRAN and other 3GPP networks (the RAN defined before the 3GPP release 8, for example, UTRAN or GERAN (GSM (Global System for Mobile Communication)/EDGE (Enhanced Data rates for Global Evolution) Radio Access Network).

The PDN GW corresponds to a termination point of a data interface to a packet data network. The PDN GW may support policy enforcement features, packet filtering, charging support, and so on. Also, the PDN GW may act as an anchor point for mobility management between the 3GPP network and non-3GPP networks (for example, an unreliable network such as the Interworking Wireless Local Area Network (I-WLAN) or reliable networks such as the Code Division Multiple Access (CDMA) network and WiMax).

In the example of a network structure as shown in FIG. 1, the SGW and the PDN GW are treated as separate gateways; however, the two gateways may be implemented according to single gateway configuration option.

The MME performs signaling for the UE's access to the network, supporting allocation, tracking, paging, roaming, handover of network resources, and so on; and control functions. The MME controls control plane functions related to subscribers and session management. The MME manages a plurality of eNodeBs and performs signaling of the conventional gateway's selection for handover to other 2G/3G networks. Also, the MME performs such functions as security procedures, terminal-to-network session handling, idle terminal location management, and so on.

The SGSN deals with all kinds of packet data including the packet data for mobility management and authentication of the user with respect to other 3GPP networks (for example, the GPRS network).

The ePDG acts as a security node with respect to an unreliable, non-3GPP network (for example, I-WLAN, WiFi hotspot, and so on).

As described with respect to FIG. 1, a UE with the IP capability may access the IP service network (for example, the IMS) that a service provider (namely, an operator) provides, via various components within the EPC based not only on the 3GPP access but also on the non-3GPP access.

Also, FIG. 1 illustrates various reference points (for example, S1-U, S1-MME, and so on). The 3GPP system defines a reference point as a conceptual link which connects two functions defined in disparate functional entities of the E-UTAN and the EPC. Table 1 below summarizes reference points shown in FIG. 1. In addition to the examples of FIG. 1, various other reference points may be defined according to network structures.

TABLE 1

| reference | |
|---|---|
| point | Description |
| S1-MME | Reference point for the control plane protocol between E- |
| | UTRAN and MME |
| S1-U | Reference point between E-UTRAN and Serving GW for the |
| | per bearer user plane tunneling and inter eNodeB path |
| | switching during handover |
| S3 | It enables user and bearer information exchange for inter |
| | 3GPP access network mobility in idle and/or active state. |
| | This reference point may be used intra-PLMN or inter-PLMN |
| | (e.g. in the case of Inter-PLMN HO). |
| S4 | It provides related control and mobility support between |
| | GPRS core and the 3GPP anchor function of Serving GW. |
| | In addition, if direct tunnel is not established, it provides the |
| | user plane tunneling. |
| S5 | It provides user plane tunneling and tunnel management |
| | between Serving GW and PDN GW. It is used for Serving |
| | GW relocation due to UE mobility if the Serving GW needs to |
| | connect to a non-collocated PDN GW for the required PDN |
| | connectivity. |
| S11 | Reference point for the control plane protocol between MME |
| | and SGW |
| SGi | It is the reference point between the PDN GW and the packet |
| | data network. Packet data network may be an operator |
| | external public or private packet data network or an intra- |
| | operator packet data network (e.g., for provision of IMS |
| | services). This reference point corresponds to Gi for 3GPP |
| | accesses. |

Among the reference points shown in FIG. 1, S2a and S2b corresponds to non-3GPP interfaces. S2a is a reference point which provides reliable, non-3GPP access, related control between PDN GWs, and mobility resources to the user plane. S2b is a reference point which provides related control and mobility resources to the user plane between ePDG and PDN GW.

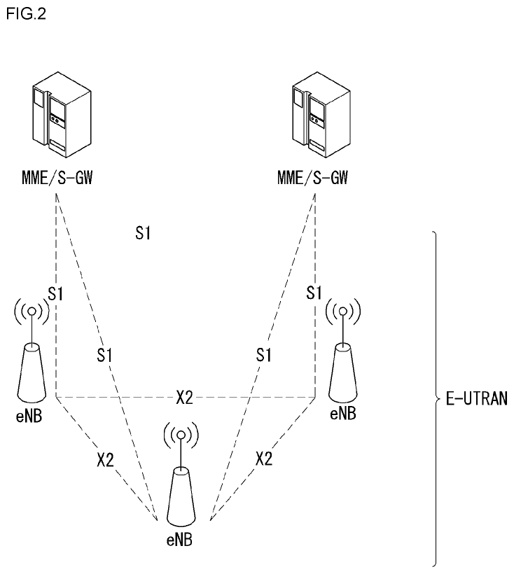

FIG. 2 illustrates one example of an Evolved Universal Terrestrial Radio Access Network (E-UTRAN) to which the present invention may be applied.

The E-UTRAN system is an evolved version of the existing UTRAN system, for example, and is also referred to as 3GPP LTE/LTE-A system. Communication network is widely deployed in order to provide various communication services such as voice (e.g., Voice over Internet Protocol (VoIP)) through IMS and packet data.

Referring to FIG. 2, E-UMTS network includes E-UTRAN, EPC and one or more UEs. The E-UTRAN includes eNBs that provide control plane and user plane protocol, and the eNBs are interconnected with each other by means of the X2 interface.

The X2 user plane interface (X2-U) is defined among the eNBs. The X2-U interface provides non-guaranteed delivery of the user plane Packet Data Unit (PDU). The X2 control plane interface (X2-CP) is defined between two neighboring eNBs. The X2-CP performs the functions of context delivery between eNBs, control of user plane tunnel between a source eNB and a target eNB, delivery of handover-related messages, uplink load management, and so on.

The eNB is connected to the UE through a radio interface and is connected to the Evolved Packet Core (EPC) through the S1 interface.

The S1 user plane interface (S1-U) is defined between the eNB and the Serving Gateway (S-GW). The S1 control plane interface (S1-MME) is defined between the eNB and the Mobility Management Entity (MME). The S1 interface performs the functions of EPS bearer service management, non-access stratum (NAS) signaling transport, network sharing, MME load balancing management, and so on. The S1 interface supports many-to-many-relation between the eNB and the MME/S-GW.

The MME may perform various functions such as NAS signaling security, Access Stratum (AS) security control, Core Network (CN) inter-node signaling for supporting mobility between 3GPP access network, IDLE mode UE reachability (including performing paging retransmission and control), Tracking Area Identity (TAI) management (for UEs in idle and active mode), selecting PDN GW and SGW, selecting MME for handover of which the MME is changed, selecting SGSN for handover to 2G or 3G 3GPP access network, roaming, authentication, bearer management function including dedicated bearer establishment, Public Warning System (PWS) (including Earthquake and Tsunami Warning System (ETWS) and Commercial Mobile Alert System (CMAS), supporting message transmission and so on.

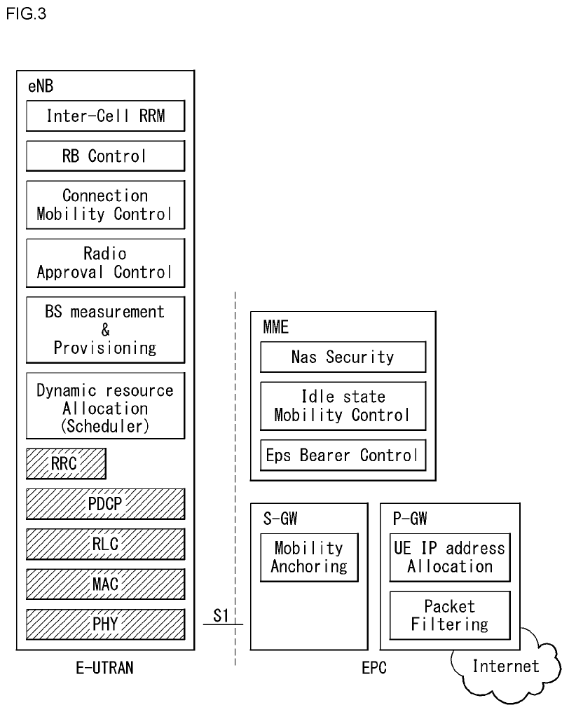

FIG. 3 exemplifies a structure of E-UTRAN and EPC in a wireless communication system to which the present invention may be applied.

Referring to FIG. 3, an eNB may perform functions of selecting gateway (e.g., MME), routing to gateway during radio resource control (RRC) is activated, scheduling and transmitting broadcast channel (BCH), dynamic resource allocation to UE in uplink and downlink, mobility control connection in LTE_ACTIVE state. As described above, the gateway in EPC may perform functions of paging origination, LTE_IDLE state management, ciphering of user plane, bearer control of System Architecture Evolution (SAE), ciphering of NAS signaling and integrity protection.

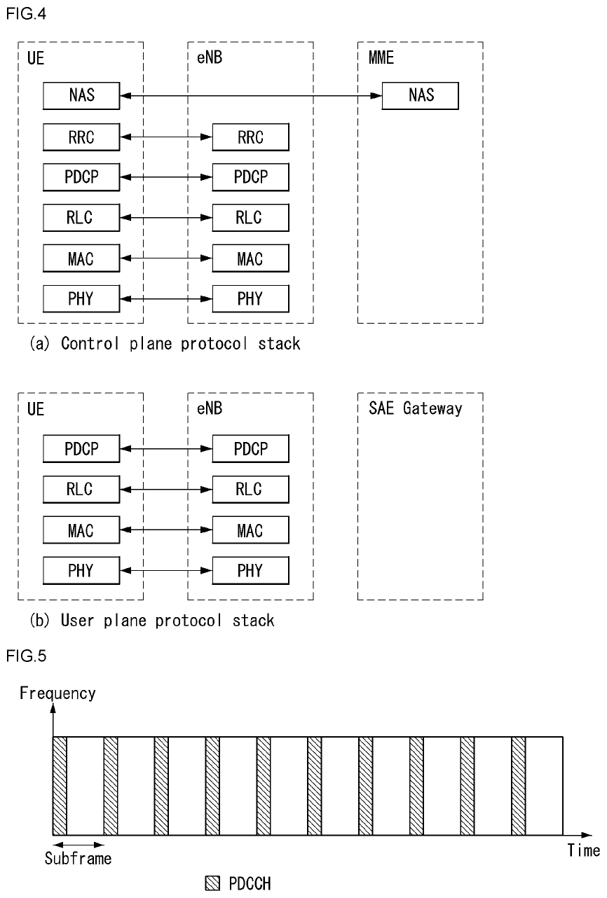

FIG. 4 illustrates a radio interface protocol structure between a UE and an E-UTRAN in a wireless communication system to which the present invention may be applied.

FIG. 4(a) illustrates a radio protocol structure for the control plane, and FIG. 4(b) illustrates a radio protocol structure for the user plane.

Referring to FIG. 4, layers of the radio interface protocol between the UE and the E-UTRAN may be divided into a first layer (L1), a second layer (L2), and a third layer (L3) based on the lower three layers of the Open System Interconnection (OSI) model, widely known in the technical field of communication systems. The radio interface protocol between the UE and the E-UTRAN consists of the physical layer, data link layer, and network layer in the horizontal direction, while in the vertical direction, the radio interface protocol consists of the user plane, which is a protocol stack for delivery of data information, and the control plane, which is a protocol stack for delivery of control signals.

The control plane acts as a path through which control messages used for the UE and the network to manage calls are transmitted. The user plane refers to the path through which the data generated in the application layer, for example, voice data, Internet packet data, and so on are transmitted. In what follows, described will be each layer of the control and the user plane of the radio protocol.

The physical layer (PHY), which is the first layer (L1), provides information transfer service to upper layers by using a physical channel. The physical layer is connected to the Medium Access Control (MAC) layer located at the upper level through a transport channel through which data are transmitted between the MAC layer and the physical layer. Transport channels are classified according to how and with which features data are transmitted through the radio interface. And data are transmitted through the physical channel between different physical layers and between the physical layer of a transmitter and the physical layer of a receiver. The physical layer is modulated according to the Orthogonal Frequency Division Multiplexing (OFDM) scheme and employs time and frequency as radio resources.

A few physical control channels are used in the physical layer. The Physical Downlink Control Channel (PDCCH) informs the UE of resource allocation of the Paging Channel (PCH) and the Downlink Shared Channel (DL-SCH); and Hybrid Automatic Repeat reQuest (HARQ) information related to the Uplink Shared Channel (UL-SCH). Also, the PDCCH may carry a UL grant used for informing the UE of resource allocation of uplink transmission. The Physical Control Format Indicator Channel (PCFICH) informs the UE of the number of OFDM symbols used by PDCCHs and is transmitted at each subframe. The Physical HARQ Indicator Channel (PHICH) carries a HARQ ACK (ACKnowledge)/NACK (Non-ACKnowledge) signal in response to uplink transmission. The Physical Uplink Control Channel (PUCCH) carries uplink control information such as HARQ ACK/NACK with respect to downlink transmission, scheduling request, Channel Quality Indicator (CQI), and so on. The Physical Uplink Shared Channel (PUSCH) carries the UL-SCH.

The MAC layer of the second layer (L2) provides a service to the Radio Link Control (RLC) layer, which is an upper layer thereof, through a logical channel. Also, the MAC layer provides a function of mapping between a logical channel and a transport channel; and multiplexing/demultiplexing a MAC Service Data Unit (SDU) belonging to the logical channel to the transport block, which is provided to a physical channel on the transport channel.

The RLC layer of the second layer (L2) supports reliable data transmission. The function of the RLC layer includes concatenation, segmentation, reassembly of the RLC SDU, and so on. To satisfy varying Quality of Service (QoS) requested by a Radio Bearer (RB), the RLC layer provides three operation modes: Transparent Mode (TM), Unacknowledged Mode (UM), and Acknowledge Mode (AM). The AM RLC provides error correction through Automatic Repeat reQuest (ARQ). Meanwhile, if MAC layer performs the RLC function, the RLC layer may be incorporated into the MAC layer as a functional block.

The Packet Data Convergence Protocol (PDCP) layer of the second layer (L2) performs the function of delivering, header compression, ciphering of user data in the user plane, and so on. Header compression refers to the function of reducing the size of the Internet Protocol (IP) packet header which is relatively large and contains unnecessary control to efficiently transmit IP packets such as the IPv4 (Internet Protocol version 4) or IPv6 (Internet Protocol version 6) packets through a radio interface with narrow bandwidth. The function of the PDCP layer in the control plane includes delivering control plane data and ciphering/integrity protection.

The Radio Resource Control (RRC) layer in the lowest part of the third layer (L3) is defined only in the control plane. The RRC layer performs the role of controlling radio resources between the UE and the network. To this purpose, the UE and the network exchange RRC messages through the RRC layer. The RRC layer controls a logical channel, transport channel, and physical channel with respect to configuration, re-configuration, and release of radio bearers. A radio bearer refers to a logical path that the second layer (L2) provides for data transmission between the UE and the network. Configuring a radio bearer indicates that characteristics of a radio protocol layer and channel are defined to provide specific services; and each individual parameter and operating methods thereof are determined. Radio bearers may be divided into Signaling Radio Bearers (SRBs) and Data RBs (DRBs). An SRB is used as a path for transmitting an RRC message in the control plane, while a DRB is used as a path for transmitting user data in the user plane.

The Non-Access Stratum (NAS) layer in the upper of the RRC layer performs the function of session management, mobility management, and so on.

A cell constituting the base station is set to one of 1.25, 2.5, 5, 10, and 20 MHz bandwidth, providing downlink or uplink transmission services to a plurality of UEs. Different cells may be set to different bandwidths.

Downlink transport channels transmitting data from a network to a UE include a Broadcast Channel (BCH) transmitting system information, PCH transmitting paging messages, DL-SCH transmitting user traffic or control messages, and so on. Traffic or a control message of a downlink multi-cast or broadcast service may be transmitted through the DL-SCH or through a separate downlink Multicast Channel (MCH). Meanwhile, uplink transport channels transmitting data from a UE to a network include a Random Access Channel (RACH) transmitting the initial control message and a Uplink Shared Channel (UL-SCH) transmitting user traffic or control messages.

Logical channels, which are located above the transport channels and are mapped to the transport channels. The logical channels may be distinguished by control channels for delivering control area information and traffic channels for delivering user area information. The control channels include a Broadcast Control Channel (BCCH), a Paging Control Channel (PCCH), a Common Control Channel (CCCH), a dedicated control channel (DCCH), a Multicast Control Channel (MCCH), and etc. The traffic channels include a dedicated traffic channel (DTCH), and a Multicast Traffic Channel (MTCH), etc. The PCCH is a downlink channel that delivers paging information, and is used when network does not know the cell where a UE belongs. The CCCH is used by a UE that does not have RRC connection with network. The MCCH is a point-to-multipoint downlink channel which is used for delivering Multimedia Broadcast and Multicast Service (MBMS) control information from network to UE. The DCCH is a point-to-point bi-directional channel which is used by a UE that has RRC connection delivering dedicated control information between UE and network. The DTCH is a point-to-point channel which is dedicated to a UE for delivering user information that may be existed in uplink and downlink. The MTCH is a point-to-multipoint downlink channel for delivering traffic data from network to UE.

In case of uplink connection between the logical channel and the transport channel, the DCCH may be mapped to UL-SCH, the DTCH may be mapped to UL-SCH, and the CCCH may be mapped to UL-SCH. In case of downlink connection between the logical channel and the transport channel, the BCCH may be mapped to BCH or DL-SCH, the PCCH may be mapped to PCH, the DCCH may be mapped to DL-SCH, the DTCH may be mapped to DL-SCH, the MCCH may be mapped to MCH, and the MTCH may be mapped to MCH.

FIG. 5 is a diagram schematically exemplifying a structure of physical channel in a wireless communication system to which the present invention may be applied.

Referring to FIG. 5, the physical channel delivers signaling and data through radio resources including one or more subcarriers in frequency domain and one or more symbols in time domain.

One subframe that has a length of 1.0 ms includes a plurality of symbols. A specific symbol (s) of subframe (e.g., the first symbol of subframe) may be used for PDCCH. The PDCCH carries information for resources which are dynamically allocated (e.g., resource block, modulation and coding scheme (MCS), etc.).

Random Access Procedure

Hereinafter, a random access procedure which is provided in a LTE/LTE-A system will be described.

The random access procedure is performed in case that the UE performs an initial access in a RRC idle state without any RRC connection to an eNB, or the UE performs a RRC connection re-establishment procedure, etc.

The LTE/LTE-A system provides both of the contention-based random access procedure that the UE randomly selects to use one preamble in a specific set and the non-contention-based random access procedure that the eNB uses the random access preamble that is allocated to a specific UE.

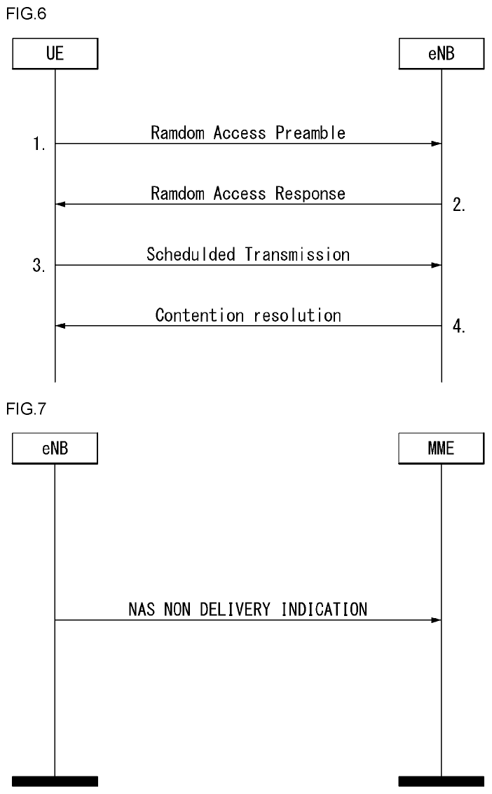

FIG. 6 is a diagram for describing the contention-based random access procedure in the wireless communication system to which the present invention may be applied.

(1) Message 1 (Msg 1)

First, the UE randomly selects one random access preamble (RACH preamble) from the set of the random access preamble that is instructed through system information or handover command, selects and transmits physical RACH (PRACH) resource which is able to transmit the random access preamble.

The eNB that receives the random access preamble from the UE decodes the preamble and acquires RA-RNTI. The RA-RNTI associated with the PRACH to which the random access preamble is transmitted is determined according to the time-frequency resource of the random access preamble that is transmitted by the corresponding UE.

(2) Message 2 (Msg 2)

The eNB transmits the random access response that is addressed to RA-RNTI that is acquired through the preamble on the Msg 1 to the UE. The random access response may include RA preamble index/identifier, UL grant that informs the UL radio resource, temporary cell RNTI (TC-RNTI), and time alignment command (TAC). The TAC is the information indicating a time synchronization value that is transmitted by the eNB in order to keep the UL time alignment. The UE renews the UL transmission timing using the time synchronization value. On the renewal of the time synchronization value, the UE renews or restarts the time alignment timer. The UL grant includes the UL resource allocation that is used for transmission of the scheduling message to be described later (Message 3) and the transmit power command (TPC). The TCP is used for determination of the transmission power for the scheduled PUSCH.

The UE, after transmitting the random access preamble, tries to receive the random access response of its own within the random access response window that is instructed by the eNB with system information or handover command, detects the PDCCH masked with RA-RNTI that corresponds to PRACH, and receives the PDSCH that is indicated by the detected PDCCH. The random access response information may be transmitted in a MAC packet data unit and the MAC PDU may be delivered through PDSCH.

The UE terminates monitoring of the random access response if successfully receiving the random access response having the random access preamble index/identifier same as the random access preamble that is transmitted to the eNB. Meanwhile, if the random access response message has not been received until the random access response window is terminated, or if not received a valid random access response having the random access preamble index same as the random access preamble that is transmitted to the eNB, it is considered that the receipt of random access response is failed, and after that, the UE may perform the retransmission of preamble.

(3) Message 3 (Msg 3)

In case that the UE receives the random access response that is effective with the UE itself, the UE processes the information included in the random access response respectively. That is, the UE applies TAC and stores TC-RNTI. Also, by using UL grant, the UE transmits the data stored in the buffer of UE or the data newly generated to the eNB.

In case of the initial access of UE, the RRC connection request that is delivered through CCCH after generating in RRC layer may be transmitted with being included in the message 3. In case of the RRC connection reestablishment procedure, the RRC connection reestablishment request that is delivered through CCCH after generating in RRC layer may be transmitted with being included in the message 3. Additionally, NAS access request message may be included.

The message 3 should include the identifier of UE. There are two ways how to include the identifier of UE. The first method is that the UE transmits the cell RNTI (C-RNTI) of its own through the UL transmission signal corresponding to the UL grant, if the UE has a valid C-RNTI that is already allocated by the corresponding cell before the random access procedure. Meanwhile, if the UE has not been allocated a valid C-RNTI before the random access procedure, the UE transmits including unique identifier of its own (for example, SAE temporary mobile subscriber identity (S-TMSI) or random number). Normally the above unique identifier is longer that C-RNTI.

If transmitting the data corresponding to the UL grant, the UE initiates a contention resolution timer.

(4) Message 4 (Msg 4)

The eNB, in case of receiving the C-RNTI of corresponding UE through the message 3 from the UE, transmits the message 4 to the UE by using the received C-RNTI. Meanwhile, in case of receiving the unique identifier (that is, S-TMSI or random number) through the message 3 from the UE, the eNB transmits the 4 message to the UE by using the TC-RNTI that is allocated from the random access response to the corresponding UE. For example, the 4 message may include the RRC connection setup message.

The UE waits for the instruction of eNB for collision resolution after transmitting the data including the identifier of its own through the UL grant included the random access response. That is, the UE attempts the receipt of PDCCH in order to receive a specific message. There are two ways how to receive the PDCCH. As previously mentioned, in case that the message 3 transmitted in response to the UL grant includes C-RNTI as an identifier of its own, the UE attempts the receipt of PDCCH using the C-RNTI of itself, and in case that the above identifier is the unique identifier (that is, S-TMSI or random number), the UE tries to receive PDCCH using the TC-RNTI that is included in the random access response. After that, in the former case, if the PDCCH is received through the C-RNTI of its own before the contention resolution timer is terminated, the UE determines that the random access procedure is performed and terminates the procedure. In the latter case, if the PDCCH is received through the TC-RNTI before the contention resolution timer is terminated, the UE checks on the data that is delivered by PDSCH, which is addressed by the PDCCH. If the content of the data includes the unique identifier of its own, the UE terminates the random access procedure determining that a normal procedure has been performed. The UE acquires C-RNTI through the 4 message, and after that, the UE and network are to transmit and receive a UE-specific message by using the C-RNTI.

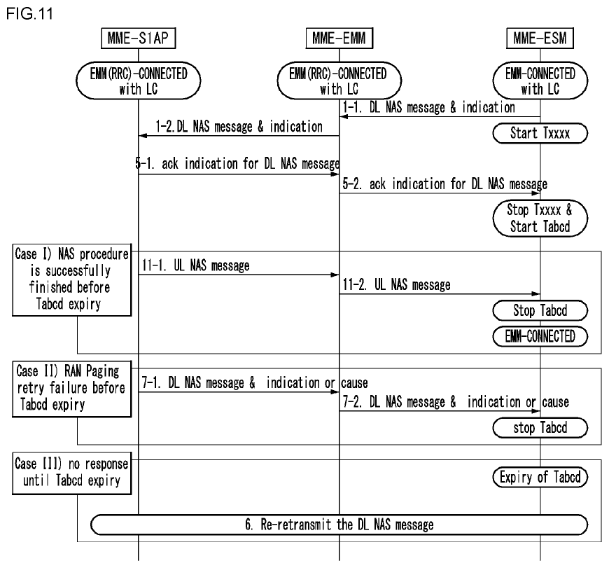

Meanwhile, the operation of the non-contention-based random access procedure, unlike the contention-based random access procedure illustrated in FIG. 11, is terminated with the transmission of message 1 and message 2 only. However, the UE is going to be allocated a random access preamble from the eNB before transmitting the random access preamble to the eNB as the message 1. And the UE transmits the allocated random access preamble to the eNB as the message 1, and terminates the random access procedure by receiving the random access response from the eNB.

Terms used in this specification are described below.

Dedicated bearer: an EPS bearer associated with an uplink packet filter(s) within a UE and a downlink packet filter(s) within a P-GW. In this case, only a specific packet is matched with the filter(s).

Default bearer: an EPS bearer established even new PDN connection. Context of a default bearer is maintained during the lifetime of a PDN connection.

EPS mobility management (EMM)-EMM-NULL state: an EPS service within a UE is deactivated. Any EPS mobility management function is not performed.

EMM-DEREGISTERED state: in the EMM-DEREGISTERED state, EMM context is not established and an MME is not notified of a UE location. Accordingly, the UE is unreachable by the MME. In order to establish EMM context, the UE needs to start an Attach or combined Attach procedure.

EMM-REGISTERED state: In the EMM-REGISTERED state, EMM context within a UE has been established and default EPS bearer context has been activated. When a UE is in the EMM-IDLE mode, an MME is notified of a UE location with accuracy of a list of TAs including a specific number of a TA. The UE may initiate the transmission and reception of user data and signaling information and may respond to paging. Furthermore, a TAU or combined TAU procedure is performed.

EMM-CONNECTED mode: when an NAS signaling connection is set up between a UE and a network, the UE is the EMM-CONNECTED mode. The term “EMM-CONNECTED” may be referred to as a term “ECM-CONNECTED state.”

EMM-IDLE mode: when an NAS signaling connection is not present between a UE and a network (i.e., an EMM-IDLE mode without suspend indication) or RRC connection suspend is indicated by a lower layer (i.e., an EMM-IDLE mode with suspend indication), the UE is in the EMM-IDLE mode. The term “EMM-IDLE” may be referred to as a term “ECM-IDLE state.”

EMM context: when an Attach procedure is successfully completed, EMM context is established between a UE and an MME.

Control plane CIoT EPS optimization: signaling optimization that enables the efficient transport of user data (IP, non-IP or SMS) through a control plane via an MME. This may optionally include the header compression of IP data.

User plane CIoT EPS optimization: signaling optimization that enables the efficient transport of user data (IP or non-IP) through a user plane.

EPS service(s): a service(s) provided by a PS domain.

NAS signaling connection: a peer-to-peer S1 mode connection between a UE and an MME. An NAS signaling connection has a concatenation of an RRC connection via an LTE-Uu interface and an S1AP connection via an S1 interface.

UE using EPS services with control plane CIoT EPS optimization: UE attached for EPS services with control plane CIOT EPS optimization approved by a network

Non-access stratum (NAS): a functional layer for exchanging an UMTS, signaling between a UE and a core network in an EPS protocol stack, and a traffic message. This has a main function of supporting the mobility of a UE and supporting a session management procedure of establishing and maintaining an IP connection between a UE and a PDN GW.

Access stratum (AS): this means a protocol layer under the NAS layer on the interface protocol between an E-UTRAN (eNB) and a UE or between an E-UTRAN (eNB) and an MME. For example, in the control plane protocol stack, the RRC layer, PDCP layer, RLC layer, MAC layer and PHY layer may be collectively referred to as an AS layer or any one of the layers may be referred to as an AS layer. Or, in the user plane protocol stack, the PDCP layer, RLC layer, MAC layer and PHY layer may be collectively referred to as an AS layer or any one of the layers may be referred to as an AS layer.

S1 mode: a mode applied to a system having functional separation according to the use of an S1 interface between a radio access network and a core network. The S1 mode includes a WB-S1 mode and an NB-S1 mode.

NB-S1 mode: this mode is applied by a UE when a serving radio access network of the UE provides access to a network service (via E-UTRA) based on a narrow band (NB)-Internet of things (IoT).

WB-S1 mode: this mode is applied when a system operates in the S1 mode, but is not the NB-S1 mode.

In 3GPP Release 14, even fora non-Public Safety UE to receive a network connection service through a relay UE, a service requests are progressing in SA1. As the UE that receive a network connection service through a relay UE, a wearable device has been discussed, representatively.

Light Connection (LC)

In 3GPP, it has discussed an influence on the NAS layer of LTE light connection and has reached the following conclusions.

The UE is in EMM-CONNECTED mode when the UE is in light RRC connection.

When a light RRC connection is resumed, it has currently agreed to the resume cause values, mobile-originated data “mo-Data”, mobile-originated signaling “mo-Signaling” and mobile-terminated access “mt-Access”. Additionally, such that emergency calls and high priority access are available during the light RRC connection, when light RRC connection is resumed, it has been considered other resume cause values, for example, “emergency” and “highPriorityAccess”. When these resume cause values are required to be used, the NAS layer provides an indication to the RRC layer.

Since it is agreed that the UE performs cell selection/reselection while in light RRC connection, the UE may move from E-UTRAN to GERAN/UTRAN while the UE is in the light RRC connection. Accordingly, in the case that the UE selects/reselects GERAN or UTRAN cell while the UE is in the light RRC connection, the UE moves to STANDBY/Packet Mobility Management (PMM)-IDLE, and then follows the legacy inter-RAT idle mode mobility procedures (i.e., performs a Routing Area Update (RAU)).

When the UE goes into the light RRC connection or goes out of the light RRC connection, the RRC layer of the UE informs it to the NAS layer.

In the case that the RRC connection is rejected during the RRC connection resumption procedure, the UE goes out of the RRC connection (RRC_CONNECTED).

The RRC layer of the UE needs to inform that resuming of the light RRC connection is failed due to the RRC Connection Reject by a network to the NAS layer. Meanwhile, the RRC layer of the UE does not need to inform a fallback to the RRC Connection Established while the light RRC connection is resumed to the NAS layer.

The light RRC connection is not usable for a roaming UE, and the UE in its own Home PLMN does not perform a PLMN selection during the light RRC connection.

Hereinafter, it is described a RAN paging failure issue in relation to the light connection.

For the RAN paging failure issue, the following scheme is proposed. RAN performs paging retry after persistent errors, and based on a local configuration, needs to release S1 connection, and an MME locally turns the UE's context to EMM-IDLE. The normal reachability is as follows;

Before releasing S1 connection, RAN sends NAS NON-DELIVERY NOTIFICATION to a Core Network (CN);

The legacy behaviour is expected from the CN, and it is not expected that the MME pages the UE as the result of the above;

RAN is expected to have a periodic Update procedure that is lesser or equal to a periodic TAU (pTAU) timer.

In relation to the RAN paging failure, a RAN paging timer value, a retry number and a paging Discontinuous Reception (DRX) parameters should be clearly specified in RAN to avoid any unnecessary NAS signalling retransmission. For any DL NAS signalling, the MME directly sends the corresponding NAS signalling to an eNB and starts a NAS timer. Currently, the NAS timer at a network side is shorter than that of a UE side and the shortest timer is 4 seconds (e.g. T3489). The UE-specific DRX cycle value may be allocated up to 2.56 seconds. In case the case that the UE moves into a cell out of the serving area of an anchor eNB but within the same paging area in which X2 paging is required, the RAN paging retry may cause NAS timer expiry and NAS signalling retransmission.

In relation to the UE mobility to 2 generation (2G)/3G and an Idle state Signaling Reduction (ISR), in current TS 24.301, the failed delivery of DL NAS signalling due to lower layer failure is treated as an abnormal case (e.g., the DL EPS Session Management (ESM) signalling delivery), and it is specified as below:

6.3.4 Abnormal Cases in the Network

The following abnormal case may be identified:

a) Lower layer indication of non-delivered NAS Protocol Data Unit (PDU) due to handover

In the case that the downlink ESM NAS message is unable to be delivered due to an intra MME handover and a target Tracking Area (TA) is included in the Tracking Area Identity (TAI) list, then upon successful completion of the intra MME handover, the MME retransmits an ESM message. In the case that a failure of the handover procedure is reported by the lower layer and the S1 signaling connection exists, the MME retransmits the downlink ESM NAS message.

For Mobile Terminated (MT)-Short Message Service (SMS) delivery, it is specified as follows:

5.6.3.5 Abnormal Cases on the Network Side

The following abnormal case may be identified:

a) Lower Layer Indication of Non-Delivered NAS PDU

In the case that the DOWNLINK NAS TRANSPORT message is not delivered for any reason, the MME may discard the message.

Except the case above, no MME behaviour is specified, and accordingly, the legacy CN behaviour may be re-used for the RAN paging failure case. It is preferable that the eNB provides a handover related S1 cause value (e.g., “S1 intra system Handover Triggered” or “X2 Handover Triggered”) to the MME in RAN paging failure cases.

Accordingly, in the case of the RAN paging failure, the legacy CN operation may not be reused, and it is required to specific a new MME operation.

In relation to the Paging Priority indication for the light connection and the NAS timer, for the case of RAN paging failure (after several retries), in the case that the MME does not initiate the CN paging based on the S1 release and non-delivery NAS PDU indication, there is a problem that it is unable to know how to handle this non-delivery NAS PDU at the MME. Accordingly, in this case, it is required to specific a new MME operation.

In the case that the MME directly discards the received non-delivery NAS PDU from the eNB after moving the UE to the idle mode, it does not make any sense for the eNB to send back the non-delivery NAS DPU to the MME. Furthermore, this causes the current ongoing NAS procedure to be failed (in the case that the MME stops the running NAS timer upon receipt of S1 release request) or causes NAS signalling retransmission after the paging (in the case that the MME keeps the NAS timer running upon receipt of S1 release request). For the latter case, the CN paging cannot be avoided since all DL NAS signalling cannot be transported to an idle UE directly. In addition, for the procedures triggered by a P-GW, there is a problem that it may cause GPRS Tunneling Protocol (GTP) timer (e.g. T3-RESPONSE timer) expiry and GTP procedure retransmissions.

For Mobile Terminated Circuit Switched FallBack (MT-CSFB) procedure, currently, there is no NAS timer for Circuit Switched (CS) service notification procedure, and accordingly, the MME behaviour without the CN paging may delay the Mobile Terminated (MT) call setup (in the case that the CN paging is successful) or delay the MT call termination (in the case that the CN paging fails).

For MT-SMS delivery, the MME operation without the CN paging may cause unnecessary MT-SMS retransmission at network.

The UE is expected to perform a periodic update procedure with a period less than or equal to the pTAU timer, and the UE may always notify the network once moves out of the current paging area. However, this may not cover all potential cases which may typically happen for a UE in the light connection (LC) mode. For example, the UE in the light connection mode moves out of paging area and enters a legacy eNB within the same TAI list, the UE attempts to notify the network (e.g. TAU), but it may be barred by a lower layer. In this case, the CN paging may be paged to the UE.

Accordingly, the new MME operation without the CN paging may cause a problem for MT signaling/CSFB/SMS process.

Hereinafter, a NAS timer issues related to the light connection is described.

Currently, in TS 24.301, the NAS timers subject to impacts of LC is specified as below.

The shortest EMM timer in a UE is 5 seconds, and the shortest ESM timer in a UE is 6 seconds.

The shortest EMM timer in a network is 6 seconds, and the shortest ESM timer in a network is 4 seconds.

In the case of uplink, for a UE in the light connection mode, the NAS layer directly sends the Mobile Originated (MO) NAS EMM/ESM messages to the RRC layer which triggers the RRC resume procedure to the eNB. Even in the case that RRC resume failure and RRC setup are fall-backed, normally all required RRC procedures may be completed within 5 seconds. In the case that the RRC resume is rejected by the eNB, the RRC layer informs this to the NAS layer, and the UE may stop the NAS timer and abort the ongoing NAS procedure. Consequently, there is no influence on the NAS timer at UE side.

In the case of downlink, as described above, the RAN paging retry may cause NAS timers expiry and NAS signaling retransmission at an MME.

To provide a simpler and backward compatible MME implementation, it is not preferable to extend all NAS timers that influence on a UE in the light connection mode. Another key point is that even in the case that the LC is activated by a CN, it is still the final decision of the eNB to move the UE into light connection mode or not. The MME is not aware of whether a UE is in the light connection mode or not. Accordingly, the MME may not provide different NAS timer handling for the LC.

There is no impact on a NAS timer at UE side but a NAS timer at MME side is impacted by the LC.

Accordingly, it is preferable not to extend the impacted NAS timers at MME side for a UE in the light connection mode.

Hereinafter, it is described a state mismatch (a network is in CONNECTED light connection mode, but a UE is in IDLE mode) issue in relation to the light connection.

The proposal that a UE always starts NAS recovery when locally moving from connected mode with the LC to idle mode is a workable way since a TAU trigger for NAS signaling connection recovery may be reused as below.

“i) when the UE receives an indication of “RRC Connection failure” from a lower layer and has no signaling or user uplink data pending (i.e., when the lower layer requests NAS signaling connection recovery);”

For the UE to listen to paging with a Suspend Identifier (ID) while the UE is in the ECM-IDLE, the UE NAS layer is not aware of the Suspend ID (i.e., Resume ID) allocated by the eNB. However, the proposal requires the UE AS layer to store the Suspend ID even in the legacy idle mode.

The existing TAU trigger may be reused for the NAS signaling recovery.

Hereinafter, it is described a PLMN selection issue in the light connection mode.

It has been discussed that “the light RRC connection is disabled for a roaming UE, and the UE in its Home PLMN (HPLMN) does not perform a PLMN selection while the UE is in the light RRC connection”.

Since only a CN knows whether a UE is an incoming roaming UE or not, the light connection may be disabled LC for the roaming UE by the CN not enabling the light connection capability to the CN for the roaming UE, or the roaming UE not signal LC capability to the CN, or by a combination of both mechanisms.

As an example of a method for an operator not to signal the light connection function to the CN, an NAS MO may be configured in a Mobile Equipment (ME) or a Universal Subscriber Identity Module (USIM) card.

Even in the case that a roaming UE signals a resource of the light connection configured by a home operator, a Visit PLMN (VPLMN) may disable the light connection for the roaming UE based on the local policies.

The LC capability is not indicated to the CN based on the configured NAS MO, and the light connection of the roaming UE is disabled. The CN in the VPLMN decides not to enable the light connection for the roaming UE that supports the light connection based on the local policy.

Hereinafter, it is described a UE operation issue when a UE in the light connection mode moves to a cell for which the eNB does not support the light connection.

About this issue, an operation of the UE is expected to inform a network when the UE moves to a cell that does not support the light connection.

However, it is not very clear what “network” refers to. If the network refers to radio access network (i.e., eNB), the RRC procedure to inform it to the eNB needs to be used and the eNB operation needs to be defined. Regardless of which the RRC procedure is used, the MME should be aware of UE's movement to a legacy eNB. Accordingly, a NAS procedure should be triggered by the UE. Typically, this NAS procedure is the TAU and the existing TAU should be reused as much as possible (e.g., “RRC Connection failure” indication from the RRC layer). Since the legacy eNB may not understand the RRC resume message and ignore it, it is not a good way that a UE uses the RRC resume procedure to inform the network.

If the network refers to a CN network, the UE needs to initiate a TAU procedure, and the existing TAU trigger should be reused as much as possible (e.g., “RRC Connection failure” indication from the RRC layer).

In the case that the target legacy cell gets out of the current TAI list, the TAU will be initiated without any further RRC layer processing. However, to provide a consistent RRC layer processing in this case, the same TAU trigger may be reused (e.g., “RRC Connection failure” indication from the RRC layer).

Accordingly, when a UE in the light connection mode moves into a legacy LTE cell for which the light connection is not supported, the existing TAU trigger (e.g., “RRC Connection failure” indication) may be reused.

In addition, in the case that the UE locally falls back to the idle mode from the light connection mode when moving into a legacy LTE cell, the same processing described above may be applied.

Hereinafter, it is described a CN report assistance issue for the light connection.

A UE should indicate its light connection capability through NAS to an MME. Based on a UE LC capability and other conditions (e.g., roaming UE, Power Saving Mode (PSM) or Extended idle-mode Discontinuous Reception (eDRX) usage), the MME may decide to send light connection enable/disable indication to an eNB. The MME may only send the LC enable/disable indication to the eNB for UE that indicated the light connection capability through NAS.

The UE that supports the light connection indicates its light connection capability through NAS to the MME (i.e., in the UE network capability Information Element (IE) in attach/TAU request message).

NAS Timer Expiry and NAS Message Retransmission

1) For the EMM message, although the TAU procedure is described below, the processing procedure for most of messages in a network (e.g., MME) is similar.

In “5.5.3.2.7 network side abnormal case” of 3GPP TS 24.301, the abnormal operation of an MME is described.

The case c) below describes an operation of the NAS timer expiry, and the case d) describes a processing of lower layer in the case of NAS PDU non-delivered case.

a) If a lower layer failure occurs before the TRACKING AREA UPDATE COMPLETE message has been received from a UE and a Globally Unique Temporary Identifier (GUTI) has been assigned, a network aborts the procedure, and enters the EMM-IDLE mode. Further, the network regards both the old and new GUTI as valid until the old GUTI may be regarded as invalid by the network. During this period, if the old GUTI is used by the UE in a subsequent message, the network may use the identification procedure followed by a GUTI reallocation procedure.

If paging with old and new S-TMSI fails, the network may page with IMSI. Paging with IMSI causes the UE to re-attach.

c) T3450 Time-Out

On the first expiry of the timer, the network retransmits the TRACKING AREA UPDATE ACCEPT message and resets and restarts timer T3450. The retransmission is performed four times (i.e., on the fifth expiry of timer T3450), the tracking area updating procedure is aborted. Both the old and the new GUTI are considered as valid until the old GUTI may be regarded as invalid by the network. During this period the network acts as described for case a above.

f) Lower Layer Indication of Non-Delivered NAS PDU Due to Handover

If the TRACKING AREA UPDATE ACCEPT message or a TRACKING AREA UPDATE REJECT message may not be delivered due to an intra MME handover and the target Tracking Area (TA) is included in the TAI list, then upon successful completion of the intra MME handover, the MME retransmits the TRACKING AREA UPDATE ACCEPT message or the TRACKING AREA UPDATE REJECT message. If a failure of the handover procedure is reported by the lower layer and the S1 signaling connection exists, the MME retransmits the TRACKING AREA UPDATE ACCEPT message or the TRACKING AREA UPDATE REJECT message.

2) For the ESM message, the processing procedure for most of ESM messages in a network (e.g., MME) is similar.

Clause 6.3 of 3GPP TS 24.301 describes a general content of the EMS procedure as below. In “6.3.4 abnormal cases in a network”, which is subclause of clause 6.3, in section a), it is described an operation of non-delivered NAS PDU in a lower layer.

a) Lower Layer Indication of Non-Delivered NAS PDU Due to Handover

If the downlink ESM NAS message may not be delivered due to an intra MME handover, and the target TA is not included in the TAI list, then upon successful completion of the intra MME handover, the MME retransmits the ESM message. If a failure of the handover procedure is reported by the lower layer and the S1 signaling connection exists, the MME retransmits the downlink ESM NAS message.

In “6.4.1.6 Default EPS bearer context activation procedure” of 3GPP TS 24.301, a transmission operation of the NAS message (i.e., Activate Default EPS Bearer Context Request message) of the MME when the NAS timer (T3485 timer) expires.

a) Expiry of Timer T3485

On the first expiry of the timer T3485, the MME retransmits the ACTIVATE DEFAULT EPS BEARER CONTEXT REQUEST message and resets and restarts the timer T3485. This retransmission is repeated four times (i.e., on the fifth expiry of the timer T3485), and the MME releases allocated resources for this activation and aborts the procedure.

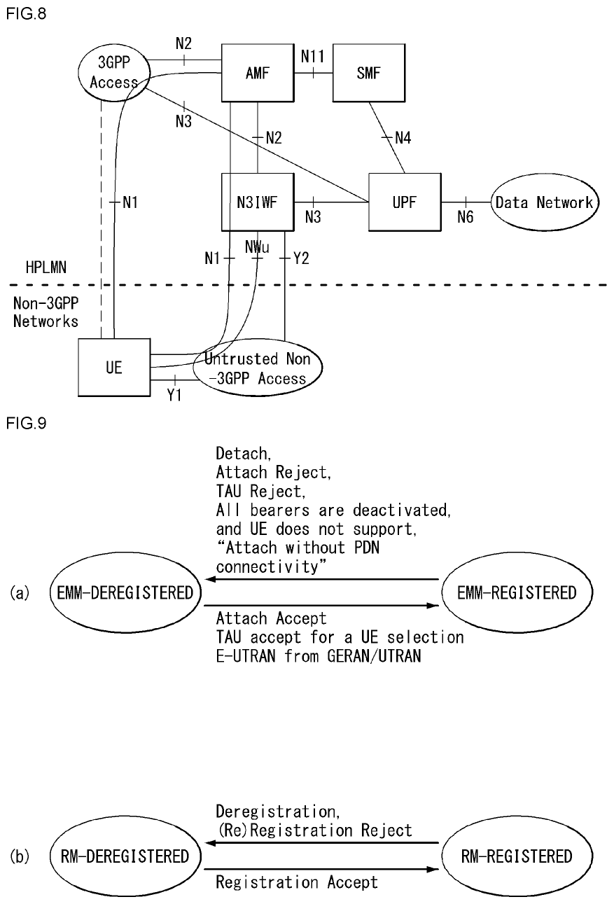

FIG. 7 is a diagram illustrating NAS non-delivery indication procedure in a wireless communication system to which the present invention may be applied.

Referring to FIG. 7, when an eNB decides not to start the delivery of a NAS message that has been received over a UE-associated logical S1-connection or the eNB is unable to ensure that the message has been received by the UE, it reports the non-delivery of this NAS message by transmitting a NAS NON-DELIVERY INDICATION message to an MME. Here, the NAS NON-DELIVERY INDICATION message includes the non-delivered NAS message within the NAS-PDU IE and an appropriate cause value (e.g., “S1 intra system Handover Triggered”, “S1 inter system Handover Triggered” or “X2 Handover Triggered”) within an appropriate Cause IE.

5 Generation (5G) System Architecture

1) Converged Access to 5G Core

FIG. 8 is a diagram illustrating a 5G system to which the present invention may be applied.

FIG. 8 illustrates a non-roaming architecture.

Referring to FIG. 8, access and core network dependencies are minimized by specifying a converged access-agnostic core with a common Access Network (AN)-Core Network (CN) interface which integrates different 3GPP and non-3GPP access types.

With this principle, the reference point (i.e., N1) between a UE and an access and mobility management function (AMF) is decided to be supported irrespective of the access type (3GPP or untrusted non-3GPP) through which the UE is connecting.

Each of Network Functions in the 5G system architecture support the following functions.

The AMF supports a function for an access and mobility management in a unit of UE, and a UE may be connected to a single AMF, basically.

Particularly, the AMF supports the functions such as signaling between CN nodes for mobility between 3GPP access networks, termination of Radio Access Network (RAN) Control Plane (CP) interface (i.e., N2 interface), NAS ciphering and integrity protection, AS security control, registration management (Registration Area management), connection management, idle mode UE reachability (including control and execution of paging retransmission), mobility management control (subscription and policy), intra-system mobility and inter-system mobility support, network slicing support, SMF selection, Lawful Intercept (for an interface to AMF event and L1 system), delivery provision of a session management (SM) message between a UE and an SMF, Transparent proxy for SM message routing, Access Authentication, Access Authentication including roaming authority check, Security Anchor Function (SEA) and Security Context Management (SCM).

Some or all the functions of the AMF may be support within a single instance of an AMF.

Data Network (DN) means an operator service, an internet access or 3^{rd} party service, and the like, for example. The DN transmits a downlink Protocol Data Unit (PDU) to a User Plane Function (UPF) or receives a PDU transmitted from a UE from the UPF.

Session Management Function (SMF) may provides a session management function and may be managed by different SMFs for each session in the case that a UE has a plurality of sessions.

Particularly, the SMF supports the functions such as session management (e.g., session establishment, modification and release, including tunnel maintenance between the UPF and the AN node), UE IP address allocation and management (including selective authentication), selection and control of UP function, traffic steering configuration for routing a traffic to an appropriate destination in the UPF, interface termination toward Policy control functions, control partial execution of policy and QoS, Lawful Intercept (for an interface to SM event and L1 system), termination of SM part of a NAS message, Downlink Data Notification, initiator of AN-specific SM information (delivered to an AN through N2 via AMF), SSC mode determination of a session and roaming function.

Sone or all the functions of the SMF may be support within a single instance of an SMF.

The UPF delivers a downlink PDU received from the DN to the UE via (R)AN and delivers an uplink PDU received from the UE to the DN via (R)AN.

Particularly, the UPF supports functions, such as an anchor point for intra/inter RAT mobility, the external PDU session point of interconnection to a data network, packet routing and forwarding, a user plane part for the execution of packet inspection and a policy rule, lawful interception, a traffic usage report, an uplink classifier for supporting the routing of traffic flow of a data network, a branching point for supporting a multi-home PDU session, QoS handling (e.g., the execution of packet filtering, gating and an uplink/downlink rate) for a user plane, uplink traffic verification (SDF mapping between a service data flow (SDF) and a QoS flow), transport level packet marking within the uplink and downlink, downlink packet buffering, and a downlink data notification triggering function. Some or all the functions of the UPF may be supported within a single instance of one UPF.

In the 3GPP system, a conceptual link that connects NFs within the 5G system is defined as a reference point. The following illustrates reference points included in 5G system architecture as represented in FIG. 8.

N1: a reference point between a UE and an AMF

N2: a reference point between an (R)AN and an AMF

N4: a reference point between an SMF and a UPF

N6: a reference point between a UPF and a data network

In the case of the untrusted non-3GPP access, functions of Non-3GPP InterWorking Function (N3IWF) are as follows:

i) IPSec tunnel establishment support with the UE: the N3IWF terminates the UE and IKEv2/IPsec protocol over NWu, authenticates the UE, and relays information required to authenticate an access for the 5G core network over N2, ii) termination of N2 and N3 interfaces to the 5G core network for each of control plane and user plane, iii) uplink and downlink control plane NAS signaling (N1) relay between UE and AMF, iv) N2 signaling control from the SMF (relayed by the AMF) associated with PDU session and QoS, v) establishment of IPsec Security Association (IPsec SA) for supporting PDU session traffic, and vi) relay of uplink and downlink user plane packet between the UE and the UPF.

Reference points for non-3GPP access are as follows.

Y1: Reference point between the UE and the non-3GPP access (e.g., WLAN). This depends on the non-3GPP access technology.

Y2: Reference point between the untrusted non-3GPP access and the N3IWF for NWu traffic transport

NWu: Reference point between the UE and N3IWF for establishing secure tunnel(s) between the UE and the N3IWF so that control plane and user plane data/signal exchanged between the UE and the 5G core network may be securely transferred over the untrusted non-3GPP access.

2) Registration Management (RM)/Connection Management (CM) and Session Management (SM)

One commonality between the 5G NAS and the EPC NAS is that there is a single terminating point for NAS ciphering and integrity protection.

The AMF provides the functions of termination of NAS, NAS ciphering and integrity protection.

However, the difference is that in 5G System RM and CM messages (referred to as Mobility Management (MM) messages in the EPC) are processed in the AMF, and SM messages are processed in the SMF.

NAS MM and SM protocol messages terminate in the AMF and the SMF, respectively. This is independent of whether SM protocol terminates in the Home-SMF (H-SMF) or Visit SMF (V-SMF).

The NAS SM messages are routed by the AMF.

In addition, a linkage between RM/CM and SM is removed (i.e., a linkage between EMM and ESM is existed in the EPS). For example, it is not mandatory to piggyback an SM message in the registration request message for always on connectivity. Furthermore, the result of registration/connection request is decoupled from the session management results (e.g., the UE switches to the EMM-DEREGISTERED state when all bears are deactivated).

RM Aspects

FIG. 9 illustrates a state mode in a wireless communication system to which the present invention may be applied.

FIG. 9(a) illustrates EMM state model in an MME for the EPS, and FIG. 9(b) illustrates RM state model in the AMF in the 5G system.

Referring to FIG. 9(a), (re-)registration to the EPS has been available via Attach and TAU procedures (and except for Cellular Internet of Things (CIoT) UEs, deactivation of all bearers affects the registration status).

Owing to Detach, Attach Reject or TAU Reject, the EMM-DEREGISTERED state is switched to the EMM-REGISTERED state. At this time, all bearers are deactivated, and the UE does not support “Attach without PDN connectivity”.

On the other hand, owing to the Attach accept and TAU accept for E-UTRAN selection from GERAN/UTRAN of the UE, the EMM-REGISTERED state is switched to the EMM-DEREGISTERED state.

Referring to FIG. 9(b), in the 5G System, the procedure for registration is common. That is, there is no Attach/TAU. In addition, RM is orthogonal to the SM.

Owing to Deregistration and (Re)Registration Reject, the RM-DEREGISTERED state is switched to the RM-REGISTERED state.

Owing to Registration Accept, the RM-REGISTERED state is switched to the RM-DEREGISTERED state.

CM Aspects

CM requires two two states: CM-IDLE and CM-CONNECTED.

Even in the case that a UE in the CM-CONNECTED state not transmitting or receiving data to achieve a comparable power efficiency to that of a UE in the CM-IDLE state (i.e., RRC-INACTIVE state), the state may be regarded as the CM-CONNECTED in the 5G Core.

On the other hand, there are some differences compared to the EPS. The Service Request procedure in the 5G System does not necessarily activate all Protocol Data Unit (PDU) sessions. Only selective or no PDU session may be activated. In addition, a UE in a non-allowed area is not allowed to initiate Service Request (as well as SM messages).

SM and Session and Service Continuity (SSC)

Bearer concept is not valid anymore in the 5G System. Instead, 5G Quality of Service (QoS) Flow is used to differentiate QoS of Service Data Flows (SDFs) within a PDU session. SM messages include QoS rules and PDU session context. In addition, reflective QoS function may be activated via Control Plane (CP) as well as User Plane (UP). In the case that the reflective QoS function is activated via CP, the SMF may include an explicit indication, that is, Reflective QoS Indication (RQI) in the QoS rule which is sent to the UE via N1 reference point.

On the other hand, three sessions and service continuity (SSC) modes are defined:

SSC mode 1: The UPF acting as anchor UPF is maintained regardless of the access technology (e.g. RATs and cells) that a UE is using to access the network.

SSC mode 2: The network may trigger the release of the PDU Session and UPF and instruct the UE to establish a new PDU session to the same data network immediately.

SSC mode 3: The network allows the establishment of UE connectivity via a new anchor UPF to the same data network before connectivity between the UE and the previous anchor UPF is terminated.

SSC mode selection is managed by SSC mode selection policy rules, and the SSC mode selection policy rules are provided to the UE and may be updated by the operator. A UE may provide an SSC mode when requesting a new PDU session.

SSC Mode 3 may be supported via IP version 6 (IPv6) multi-homing.

Removal of N2 Stickiness

It is agreed that the architecture may support mechanisms to avoid issues caused by the persistence (i.e., “stickiness”) of UE-specific associations on at least N2. This agreement may impact temporary Identifier (ID) allocation. Furthermore, load balancing TAU is not necessary since there exists no stickiness between the UE and the AMF.

NAS Message Transmission and Reception Method in Light Connection or Inactive Mode

According to the RAN paging failure, the potential CN impact, a discussion in 3GPP is as below.

RAN performs paging retry, after persistent error and based on local configuration, and locally turns the UE's context to the EMM-IDLE. Before releasing S1 connection, RAN sends NAS NON-DELIVERY NOTIFICATION to a CN.

A UE remains in light connected in this scenario.

A legacy behavior from the CN is expected.

It is expected that an MME does not page the UE as the result of the above.

It is expected a periodic Update procedure that is less than or equal to the periodic TAU (pTAU) timer.

At this time, the following matters are under discussion.

For the RAN paging failure, the RAN paging timer value, the retry number and the paging DRX parameters need to be clearly specified in RAN to avoid any unnecessary NAS signalling retransmission. For any DL NAS signalling, the MME directly sends the corresponding NAS signalling to the eNB and start a NAS timer. Currently, the NAS timer at network side is shorter than that of UE side, and the shortest one is 4 seconds (e.g., T3489). The UE-specific DRX cycle value may be allocated up to 2.56 seconds. In the case that the UE moves into a cell out of the serving area of anchor eNB but within the same paging area in which X2 paging is required, the RAN paging retry may likely to cause NAS timer expiry and NAS signalling retransmission.

An example of the operation above is described in “NAS timer expiry and NAS signalling retransmission” described above, and the operation for processing Non-delivered NAS message is illustrated in FIG. 7 above. In addition, “NAS timer expiry and NAS signalling retransmission” is described only for the case of handover failure but may be extendedly applied to the case of RNA paging failure in the light connection.

According to a proposal discussed in 3GPP, it is tried to inform the concerning for NAS timer expiry and NAS signalling retransmission to RAN, considering that the current NAS timer is at least 4 seconds and the maximum value of UE-specific DRX is 2.56 seconds, NAS timer expiry and NAS signalling retransmission correspond to an unavoidable problem.

As described above, in the case that NAS timer expiry and NAS signalling retransmission occur, as described in “NAS timer expiry and NAS signalling retransmission” above, the NAS layer tries a retransmission of NAS PAU (or NAS message) up to 5 times. In addition, in the case that the transmission attempt of the fifth NAS PAU (or NAS message) is also failed, the MME switches a state of the corresponding UE to the EMM-IDLE state and regards the information of the UE (i.e., GUTI of the UE) as invalid. Assuming that RAN is trying to page even before the fifth corresponding retransmission operation, an unnecessary S1-AP signalling (between the eNB and the MME) occurs.

In addition, according to the existing operation, the case that the MME transmits DL NAS message corresponds to the case that the UE is in the EMM-CONNECTED mode (except paging), generally. Accordingly, in the case of S1-AP message that encapsulates and transmits DL NAS message, it is not required to check whether a transmission of the corresponding S1-AP message is succeeded in the MME. In this case, in the case that a transmission of DL NAS message is failed, the MME may identify Non-delivered NAS message using the procedure illustrated in FIG. 7. However, there is a problem that the case of the Non-delivered NAS message is applied only to a specific case of handover.

However, in the EMM-CONNECTED mode accompanied by the light connection, S1 connection (i.e., between the eNB and the MME) is established but RRC connection (i.e., between the eNB and the MME) is not established. In such an environment, different from the existing EMM-CONNECTED, a probability of succeeding a DL NA message delivery becomes lowed, and delay for establishing the RRC connection occurs. Accordingly, in the case that MME-NAS layer performs the NAS procedure of transmitting the DL NAS message in the same way as the MME-NAS layer performs in the existing EMM-CONNECTED mode in this situation, there is a problem that a probability of succeeding a DL NA message delivery becomes lowed. Furthermore, owing to the delay for establishing the RRC connection between the UE and the eNB, there is a problem that NAS timer expires in the MME NAS layer, and owing to this, NAS signaling retransmission is frequently occurred.

To solve the problem, the present invention proposes a method of reducing unnecessary NAS message retransmission for the UE in the light connection state and signaling of S1-AP interface.

Hereinafter, for the convenience of description, the embodiment that the present invention is applied to the EPS system is mainly described, but the present invention is not limited thereto, and it is apparent that the present invention may be applied to the UE in the RRC Inactive state in the same way.

The light connection state means a state that a UE may move in a preconfigured area while maintaining the EMM-CONNECTED mode without notifying it to RAN (eNB). In the light connection state, the last serving eNB maintains a UE-context and UE-related S1 connection between a serving MME and an S-GW (S1-MME and S1-U). On the other hand, since a connection is released between the UE and the eNB while the UE is in the light connection state, when the last serving eNB receives downlink data from the S-GW and receives downlink signaling from the MME, the eNB pages in the cell that corresponds to the preconfigured area. In addition, in the case that the preconfigured area includes a cell of neighboring eNB(s), the eNB may transmit X2 paging to the neighboring eNB(s).

Similarly, the RRC Inactive state means a state that a UE may move in a preconfigured area by RAN (i.e., RAN-based Notification Area (RNA)) while maintaining the Connection Management (CM)-CONNECTED mode without notifying it to RAN (eNB). In the RRC Inactive state, the last serving gNB maintains UE-context and maintains UE-related NG connection (N2 and N3) with serving AMF and UPF. On the other hand, while the UE is in the RRC Inactive state, since a connection between the UE and the gNB is released, when the last serving gNB receives downlink data from the UPF and receives downlink signaling from the AMF, the gNB pages in the cell that corresponds to the RNA. In addition, in the case that the RNA includes a cell of neighboring gNB(s), the gNB may transmit X2 paging to the neighboring gNB(s).

The following illustrates a mapping relation between the terms used in the EPC and the terms used in the 5G system.

light connection (LC): in-active

EMM-CONNECTED (RRC-CONNECTED) mode with LC: In-active mode

MME: AMF (or SMF)

MME-EMM (EMM layer): AMF (5GMM layer)

MME-ESM (ESM layer): SMF (5GSM layer)

S1AP (interface/message): N2 (interface/message)

NAS (interface/message): N1 (interface/message)

In addition, in the 5G system, MME-EMM is mapped to AMF, MME-ESM is mapped to SMF, the interface between MME-EMM and MME-AMF is mapped to N11, and the interface between MME-EMM and eNB is mapped to N2.

Accordingly, according to the mapping relation described above, the description of the present invention below is replaced, and hereinafter, the description of the present invention may be applied to the 5G system in the same way.

### Embodiment 1

This embodiment proposes a method for reducing unnecessary NAS retransmission for the UE in the light connection and signaling of S1-AP period (interface).

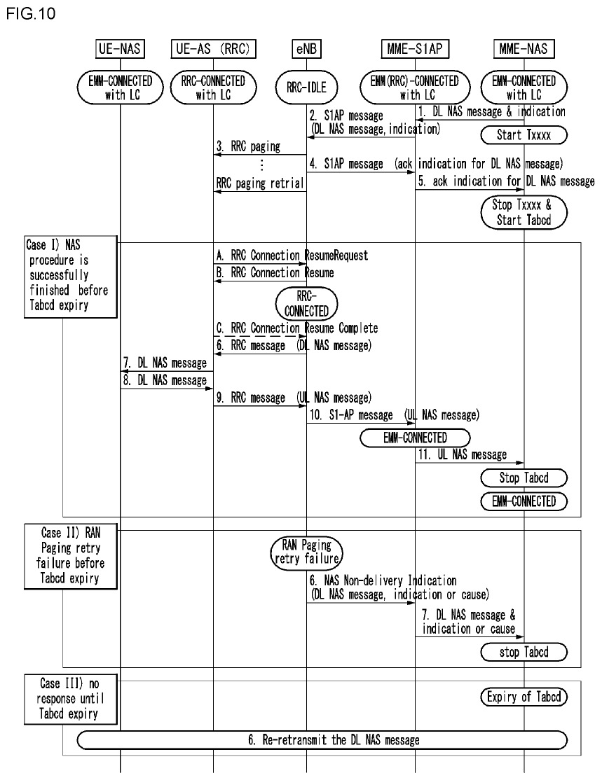

Referring to FIG. 10 below, the case that an MME transmits downlink (DL) NAS message is described. In FIG. 10, the DL NAS message may be an EMM message or an ESM message. In addition, it is assumed that a UE is in the EMM-CONNECTED (NAS layer)/RRC-CONNECTED (RRC layer) state with the light connection.

FIG. 10 is a diagram illustrating a method for transmitting and receiving downlink NAS message according to an embodiment of the present invention.

Step 1) The NAS layer of an MME (MME-NAS) forwards a DL NAS message to the S1AP layer of the MME (MME-S1AP) for DL NAS message transmission. At this time, the MME-NAS layer starts timer Txxxx. The Txxxx means timers related to a transmission of the DL NAS message executed by the MME-NAS layer.

A. The MME-NAS layer may include the EMM layer and the ESM layer. That is, in this embodiment, the DL NAS message may include all DL EMM NAS messages and DL ESM messages.

As an example of the EMM procedure, the DL NAS message may be an AUTHENTICATION REQUEST message, and in this case, Txxxx may correspond to T3460. As an example of the ESM procedure, the DL NAS message may be MODIFY EPS BEARER CONTEXT REQUEST message, and in this case, Txxxx may correspond to T3486.

B. In the case that the MME-NAS layer wants to perform a response operation (the operation of step 4) of the eNB for the DL NAS message, an indication for requesting a response of the eNB may be included. That is, the MME-NAS layer may deliver an indication with the DL NAS message (or with being included in the DL NAS message) to the MME-S1AP layer. For example, the indication may be an indication for requesting an Acknowledgement (ACK) for the DL NAS message (delivery).

In addition, since the MME-NAS layer may not know the light connection of the UE, and accordingly, there is a DL NAS message to deliver to the UE, the indication may be interpreted as an indication for requesting to initiate an operation for establishing a connection between the eNB and the UE (e.g., RAN paging initiation, etc.).

At this time, in the case that the MME-NAS layer wants to perform a response operation (the operation of step 4) of the eNB, the condition for performing to forward the indication to the MME-S1AP layer additionally may be associated with the transmission number of the DL NAS message. For example, when transmitting the first DL NAS message and/or transmitting the second DL NAS message and/or transmitting the last DL NAS message, the MME-NAS layer may forward the indication to the MME-S1AP layer.

Step 2) When the MME-S1AP layer receives the DL NAS message, the MME-S1AP layer encapsulates the DL NAS message in an S1AP message (e.g., DL NAS TRANSPORT message) and transmits it to the eNB.

A. The S1AP message described above may not include the DL NAS message received from the MME-NAS layer. That is, even in the case that the MME-S1AP layer receives the DL NAS message from the MME-NAS layer, the MME-S1AP layer may not encapsulate the DL NAS message in an S1AP message, but only transmit the S1AP message to the eNB.

B. At this time, in the case that the MME-S1AP layer receives an indication (e.g., ACK request indication for DL NAS message (delivery)) from the MME-NAS layer in step 1 above, the MME-S1AP layer may transmit the first indication with being included in the corresponding S1AP message to the eNB.

C. In addition, even in the case that the MME-S1AP layer does not receive an indication (e.g., ACK request indication for DL NAS message (delivery)) from the MME-NAS layer in step 1 above (i.e., without the operation of the MME-NAS layer to forward the indication to the MME-S1AP layer), the MME-S1AP layer may include the indication in the S1AP message autonomously and transmit it to the eNB.

Here, like the indication described above, this indication may mean an indication for indicating a start of connection between the eNB and the UE since there is a DL NAS message to forward to the UE (or for requesting a notification when a connection is established between the eNB and the UE).

That is, in the case that the MME-S1AP layer wants to perform a response operation (the operation of step 4) of the eNB, the MME-S1AP layer may include the indication in the S1AP message.

At this time, in the case that the MME-S1AP layer wants to perform a response operation (the operation of step 4) of the eNB, the condition for performing to forward the indication to the eNB may be associated with the transmission number of the DL NAS message. For example, when transmitting the first DL NAS message and/or transmitting the second DL NAS message and/or transmitting the last DL NAS message, the MME-S1AP layer may forward the indication with being included in the S1AP message to the eNB. For this operation, the MME-NAS layer may inform an attempt counter for the DL NAS message transmission to the MME-S1AP layer, or the MME-S1AP layer may compute the attempt counter for the DL NAS message.

Step 3) The eNB that receives the S1AP message (e.g., DL NAS TRANSPORT message) from the MME-S1AP layer performs RAN paging. That is, since the corresponding UE is in the RRC-CONNECTED state with the light connection, the eNB transmits the RRC paging message to the UE.

At this time, when the eNB identifies that the DL NAS message is included in the S1AP message received from the MME-S1AP message, the eNB may perform RAN paging.

Step 4) In the case that the eNB identifies that the indication (e.g., ACK request indication for DL NAS message (delivery)) is included in the received S1AP message, the eNB transmits ACK indication indicating to receive the DL NAS message successfully (e.g., ACK indication for DL message (delivery)) with being included in the S1AP message to the MME-S1AP layer.

Here, the indication may be interpreted as an indication for responding (notifying) that an operation for establishing a connection between the eNB and the UE is started (e.g., RAN paging is started, etc.).

At this time, the S1AP message may be the existing S1AP message or newly defined S1AP message.

Step 5) The MME-S1AP layer forwards the ACK indication (e.g., ACK indication for DL message (delivery)) received from the eNB to the MME-NAS layer.

The MME-NAS layer that receives the ACK indication (e.g., ACK indication for DL message (delivery)) may identify that the DL NAS message is successfully forwarded to the eNB (or identify that an operation for establishing an RRC connection between the eNB and the UE). And, the MME-NAS layer stops Txxxx and starts a new timer Tabcd.

Hereinafter, several cases that may occur thereafter are distinguished, and the operation is described for each case.

Case 1) A Case that the NAS Procedure is Successfully Completed Before Tabcd Timer Expires

Steps A to C) The AS layer of the UE (UE-AS) (e.g., RRC layer of the UE) performs an operation for establishing an RRC connection when receiving RAN paging.

That is, when the UE transmits the RRC Connection Resume Request message to the eNB, and the eNB accepts the RRC Connection Resume, in response to this, the eNB transmits the RRC Connection Resume message to the UE. After completing this step, the eNB and/or the UE may be switched to the RRC-CONNECTED state. In addition, in response to the RRC Connection Resume message, the UE may transmit the RRC Connection Resume Complete message to the eNB. After completing this step, the eNB and/or the UE may be switched to the RRC-CONNECTED state.

Step 6) When the RRC connection is successfully established, the eNB performs an operation for transmitting the DL NAS message. That is, the eNB transmits the DL NAS message by encapsulating it in the RRC message to the UE.

Step 7) The UE-AS layer (RRC layer) that receives the DL NAS message forwards the corresponding DL NAS message to the UE-NAS layer.

Step 8) The UE-NAS layer that receives the DL NAS message forwards the UL NAS message to the UE-AS layer (RRC layer) to transmit the UL NAS message.

Step 9) The UE-AS layer (RRC layer) transmits the UL NAS message to the eNB. That is, the UE-AS layer transmits the UL NAS message by encapsulating it in the RRC message to the eNB.

Step 10) The eNB transmits the UL NAS message to the MME-S1AP layer. That is, the eNB transmits the UL NAS message by encapsulating it in the S1AP message to the MME-S1AP layer.

After completing this step, the MME-S1AP layer is switched to the EMM-CONNECTED state.

Step 11) The MME-S1AP layer forwards the UL NAS message to the MME-NAS layer.

The MME-NAS layer that receives this stops Tabcd, identifies that the DL NAS message is successfully transmitted to the UE, and is switched to the EMM-CONNECTED state.

Case II) RAN Paging Retry Failure Before Tabcd Expiry

Step 6) In the case that the eNB performs RAN paging retry and is failed, the eNB informs the failure of the RAN paging retry to the MME.

At this time, the S1AP message used for informing the failure of the RAN paging retry to the MME may be the predefined S1AP message or a newly defined S1AP message.

Here, as an example of the predefined S1AP message, NAS Non-delivery Indication message may be used. The NAS Non-delivery Indication message may include the DL NAS message received in step 2 above. In addition, the NAS Non-delivery Indication message may include an indication or cause. An example of the indication or cause may be failure of the RAN paging retry, failure of RRC connection establishment or ‘DL NAS PDU is not delivered’.

On the other hand, in the case of the newly defined S1AP message, a message for informing failure of the RAN paging retry or failure of RRC connection establishment or a message for informing that NAS PDU is not delivered may be used. In this case, the newly defined S1AP message may include an indication or cause for informing failure information. In addition, the newly defined S1AP message may include or may not include the DL NAS message.

Step 7) The MME-S1AP layer that receives the S1AP message forwards the DL NAS message (in the case that the DL NAS message is included) included in the S1AP message and/or the indication (or cause) to the MME-NAS layer. The MME-NAS layer that receive this stops timer Tabcd and determines that a transmission of the DL NAS message is impossible.

Later, the MME-NAS layer may be switched to the EMM-IDLE mode. Or, the MME-NAS layer may perform steps 1 to 5 above again in the EMM-CONNECTED mode with the light connection.

Case III) A Case That There is No Response Until Tabcd Expires

In the case that the MME-NAS layer is unable to receive any response until timer Tabcd expires (i.e., in the case that case I nor case II is not occurred), the MME-NAS layer determines that a transmission of the DL NAS message is impossible, and the MME-NAS layer is switched to the EMM-IDLE mode, or the MME-NAS layer may perform steps 1 to 5 above again in the EMM-CONNECTED mode with the light connection.

In step 1 above, after the MME-NAS layer transmits the DL NAS message, in the case that the NAS procedure for transmitting a new DL NAS message is triggered, the corresponding NAS procedure may not performed but may be pending. That is, the triggered NAS procedure may be pending for transmitting a new DL NAS message until the MME-NAS layer identifies that the previously transmitted DL NAS message is successfully forwarded to the UE or an RRC connection is established.

In addition, when the MME-NAS layer identifies that the previously transmitted DL NAS message is successfully forwarded to the UE or an RRC connection is established, the pending NAS procedure may be triggered (started).

The operation of step 4 shown in FIG. 10 may be performed whenever the MME transmits the NAS message or performed when only corresponding to a specific case.

Here, an example for the case that the operation is performed when only corresponding to a specific case is as below.

a) Transmission of the first NAS message, or

b) Transmission of the second NAS message, or

c) Transmission of the last NAS message, or

d) Transmission every time

The case of performing step 4 every time above may cause signaling of unnecessary S1AP period (interface) in comparison with the existing case, considering the case that the eNB performs paging retry.

In addition, the case that the eNB performs step 4 above only when transmitting the first NAS message, considering that the eNB performs paging retry and the first NAS message transmission is succeeded, may cause signaling overhead in comparison with the case of b) or c) above.

In FIG. 10 above, it is exemplified that the UL NAS message is existed in response to the corresponding message for the DL NAS message, but the present invention is not limited thereto.

Meanwhile, as described above, the MME-NAS layer may include MME-EMM layer and MME-ESM layer.

In the case that the MME-EMM layer transmits the DL NAS message, by regarding the MME-NAS layer in FIG. 10 above as the same entity as the MME-EMM layer, this embodiment may be applied in the same manner.

On the other hand, in the case that the MME-EMM layer transmit the DL NAS message, as shown in FIG. 11 below, the MME-ESM layer may interact with the MME-S1AP through the MME-EMM layer. This is described with reference to FIG. 11 below.

FIG. 11 is a diagram illustrating a method for transmitting and receiving DL NAS message according to an embodiment of the present invention.

Referring to FIG. 11, in the embodiment according to FIG. 10 above, the MME-NAS layer may be distinguished into the MME-EMM layer and the MME-ESM layer, and it is exemplified the case that the DL NAS message to forward to the UE is generated in the MME-ESM layer of FIG. 11. In this case, the MME-ESM layer may forward the DL NAS message (and indication) to the MME-S1AP layer via the MME-EMM layer, and on the contrary, the MME-ESM layer may receive the ACK indication for DL NAS message, UL NAS message or DL NAS message & indication or cause from the MME-S1AP layer via the MME-EMM layer.

In addition, in the case that the present invention is applied to the 5G system, the MME-EMM may correspond to the AMF, the MME-ESM may correspond to the SMF, the interface between the MME-EMM (i.e., AMF) and the MME-ESM (i.e., SMF) may correspond to N11 and the interface between the MME-EMM (i.e., AMF) and the eNB may correspond to N2. That is, in FIG. 11, the MME-EMM may be replaced by the AMF, the MME-ESM may be replaced by the SMF, and it is interpreted as the case that the NAS message to be forwarded to the UE is generated in the SMF.

### Embodiment 2

In this embodiment, it is proposed a method for reducing unnecessary NAS retransmission for the UE in the light connection state and signaling of S1-AP period (interface).

This embodiment may be applied to the UL NAS message transmission as well as the DL NAS message transmission.

1) Embodiment 2-1: DL NAS Message Transmission

In this embodiment, different from embodiment 1 above, in the case that a DL NAS message transmission is required (or triggered), the DL NAS message transmission is not performed directly, but a notification that the DL NAS message transmission is required may be informed to the eNB. And, in the case that after the eNB forwards a response to it, the eNB informs that the RRC connection is established to the MME, the MME may be switched from the EMM-CONNECTED mode with the light connection to the EMM-CONNECTED mode and perform an operation of transmitting the DL NAS message in the same manner as previously.

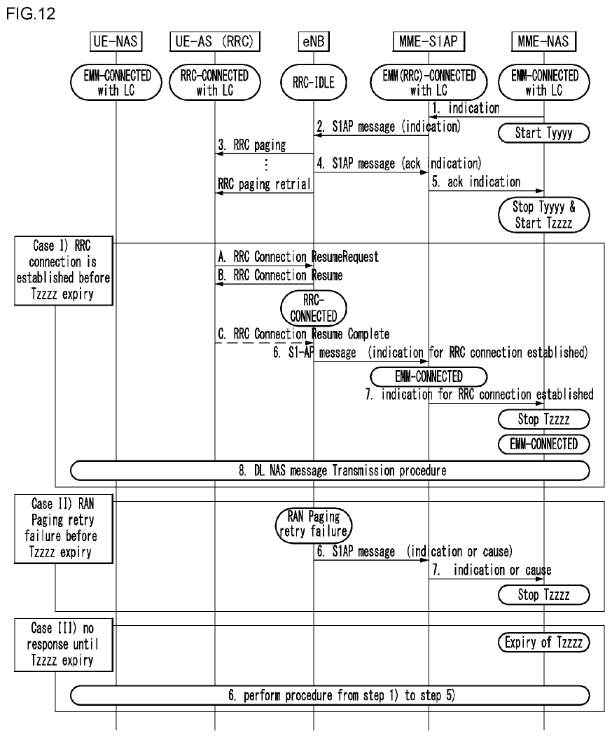

FIG. 12 is a diagram illustrating a method for transmitting and receiving DL NAS message according to an embodiment of the present invention.

Step 1) In the case that a DL NAS message transmission is required, the NAS layer of an MME (MME-NAS) forwards an indication that the DL NAS message transmission is required to the S1AP layer of the MME (MME-S1AP). For example, the indication may be an indication for requesting (DL) NAS message delivery.

In addition, since the MME-NAS layer does not know the light connection of the UE, and accordingly, there is a DL NAS message to forward to the UE, the indication may be interpreted as an indication for requesting to start an operation for establishing a connection between the eNB and the UE (e.g., RAN paging start, etc.).

And, the MME-NAS layer starts timer Tyyyy to identify that the corresponding indication is successfully forwarded to the eNB.

A. The MME-NAS layer may include the EMM layer and the ESM layer. That is, in this embodiment, the DL NAS message may include all DL EMM NAS messages and DL ESM messages.

As an example of the EMM procedure, the DL NAS message may be an AUTHENTICATION REQUEST message. As an example of the ESM procedure, the DL NAS message may be MODIFY EPS BEARER CONTEXT REQUEST message.

Step 2) When the MME-S1AP layer receives the indication (e.g., indication for requesting (DL) NAS message transmission), the MME-S1AP layer transmits the corresponding indication with being included in the S1AP message to the eNB.

A. Here, the S1AP message may be a newly defined S1AP message. For example, the S1AP message may be (DL) NAS MESSAGE INDICATION message. In addition, the S1AP message does not include the NAS message.

Step 3) When the eNB identifies that the indication (indication for requesting (DL) NAS message transmission) is included in the received S1AP message, the eNB performs RAN paging.

Step 4) In the case that the eNB identifies that the indication (e.g., indication for requesting (DL) NAS message transmission) is included in the received S1AP message, the eNB transmits ACK indication indicating to receive the corresponding indication successfully (e.g., ACK indication for requesting (DL) NAS message transmission) with being included in the S1AP message to the MME-S1AP layer.

Here, the ACK indication may be interpreted as an indication for responding (notifying) that an operation for establishing a connection between the eNB and the UE is started (e.g., RAN paging is started, etc.).

At this time, the S1AP message may be the existing S1AP message or newly defined S1AP message. For example, the S1AP message may be (DL) NAS MESSAGE ACK INDICATION message.

Step 5) The MME-S1AP layer forwards the ACK indication (e.g., ACK indication for requesting (DL) NAS message transmission) received from the eNB to the MME-NAS layer.

The MME-NAS layer that receives the ACK indication (e.g., ACK indication for requesting (DL) NAS message transmission) may identify that the DL NAS message is successfully forwarded to the eNB (or identify that an operation for establishing an RRC connection between the eNB and the UE). And, the MME-NAS layer stops Tyyyy and starts a new timer Tzzzz.

Meanwhile, in the case that the MME-NAS layer fails to receive the ACK indication from the eNB until timer Tyyyy expires, steps may be performed again from step 1 above.

Hereinafter, several cases that may occur thereafter are distinguished, and the operation is described for each case.

Case 1) A Case That the RRC Connection is Successfully Established Before Tzzzz Timer Expires

Steps A to C) The AS layer of the UE (UE-AS) (e.g., RRC layer of the UE) performs an operation for establishing an RRC connection when receiving RAN paging.

That is, when the UE transmits the RRC Connection Resume Request message to the eNB, and the eNB accepts the RRC Connection Resume, in response to this, the eNB transmits the RRC Connection Resume message to the UE. After completing this step, the eNB and/or the UE may be switched to the RRC-CONNECTED state. In addition, in response to the RRC Connection Resume message, the UE may transmit the RRC Connection Resume Complete message to the eNB. After completing this step, the eNB and/or the UE may be switched to the RRC-CONNECTED state.

Step 6) When the RRC connection is successfully established, the eNB transmits the indication for RRC connection establishment for informing it with being included in the S1AP message to the MME-S1AP layer.

Here, the S1AP message may be a newly defined S1AP message. For example, the S1AP message may be RRC CONNECTION INDICATION or RRC CONNECTED INDICATION message.

Step 7) The MME-S1AP layer that receives the S1AP message is switched to the EMM-CONNECTED mode. And, the MME-S1AP layer forwards the indication for RRC connection establishment included in the corresponding S1AP message to the MME-NAS layer. The MME-NAS layer that receives the indication for RRC connection establishment is switched to the EMM-CONNECTED mode and stops timer Tzzzz.

Step 8) The MME-NAS layer performs the DL NAS message transmission procedure according to the existing scheme.

Case II) RAN Paging Retry Failure Before Tzzzz Expiry

Step 6) In the case that the eNB performs RAN paging retry and is failed, the eNB informs the failure of the RAN paging retry to the MME.

At this time, the S1AP message used for informing the failure of the RAN paging retry to the MME may be the predefined S1AP message or a newly defined S1AP message.

Here, as an example of the predefined S1AP message, NAS Non-delivery Indication message may be used. In addition, an example of the newly defined S1AP message may be RRC CONNECTION FAILURE INDICATION or RRC CONNECTED FAILURE INDICATION message.

The S1AP message does not include the NAS message. On the other hand, the S1AP message may include an indication or cause. An example of the indication or cause may be failure of RAN paging retry or failure of RRC connection establishment.

Step 7) The MME-S1AP layer that receives the S1AP message forwards the indication or cause included in the S1AP message to the MME-NAS layer. The MME-NAS layer that receive this stops timer Tzzzz and determines that a transmission of the DL NAS message is impossible.

At this time, the MME-NAS layer may be switched to the EMM-IDLE mode or perform steps 1 to 5 above again in the EMM-CONNECTED mode with the light connection.

Case III) A Case That There is No Response Until Tzzzz Expires

In the case that the MME-NAS layer is unable to receive any response until timer Tzzzz expires (i.e., in the case that case I nor case II is not occurred), the MME-NAS layer determines that establishment of the RRC connection is impossible, and the MME-NAS layer is switched to the EMM-IDLE mode, or the MME-NAS layer may perform steps 1 to 5 above again in the EMM-CONNECTED mode with the light connection.

Meanwhile, as described above, the MME-NAS layer may include MME-EMM layer and MME-ESM layer.

In the case that the MME-EMM layer transmits the DL NAS message, by regarding the MME-NAS layer in FIG. 10 above as the same entity as the MME-EMM layer, this embodiment may be applied in the same manner.

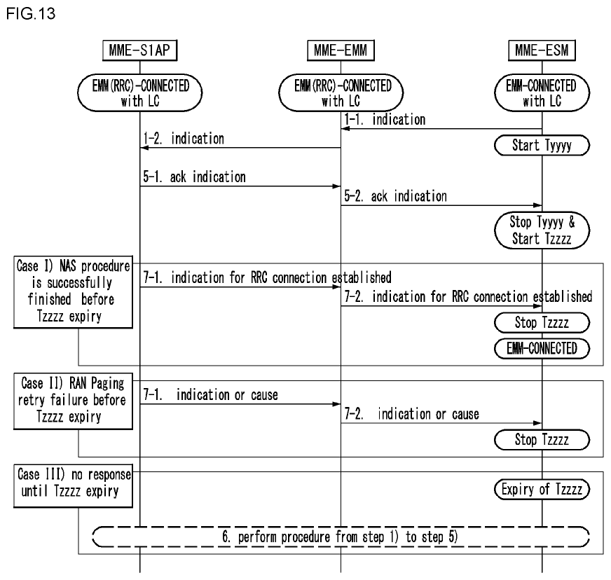

On the other hand, in the case that the MME-EMM layer transmit the DL NAS message, as shown in FIG. 13 below, the MME-ESM layer may interact with the MME-S1AP through the MME-EMM layer. This is described with reference to FIG. 13 below.

FIG. 13 is a diagram illustrating a method for transmitting and receiving DL NAS message according to an embodiment of the present invention.

Referring to FIG. 13, in the embodiment according to FIG. 12 above, the MME-NAS layer may be distinguished into the MME-EMM layer and the MME-ESM layer, and it is exemplified the case that the DL NAS message to forward to the UE is generated in the MME-ESM layer of FIG. 13. In this case, the MME-ESM layer may forward the indication to the MME-S1AP layer via the MME-EMM layer, and on the contrary, the MME-ESM layer may receive the ACK indication, the indication for RRC connection establishment, the indication or cause for failure of RRC connection establishment from the MME-S1AP layer via the MME-EMM layer.

In addition, in the case that the present invention is applied to the 5G system, the MME-EMM may correspond to the AMF, the MME-ESM may correspond to the SMF, the interface between the MME-EMM (i.e., AMF) and the MME-ESM (i.e., SMF) may correspond to N11 and the interface between the MME-EMM (i.e., AMF) and the eNB may correspond to N2. That is, in FIG. 11, the MME-EMM may be replaced by the AMF, the MME-ESM may be replaced by the SMF, and it is interpreted as the case that the NAS message to be forwarded to the UE is generated in the SMF.

2) Embodiment 2-2: UL NAS Message Transmission

In this embodiment, similar to embodiment 2-1 above: DL NAS message transmission method, in the case that a UL NAS message transmission is required (or triggered), the UL NAS message transmission is not performed directly, but the NAS layer of the UE (UE-NAS) may inform that the UL NAS message transmission is required may be informed to the AS layer (e.g., RRC layer) of the UE (UE-RRC). And, in the case that after the UE-AS layer establishes an RRC connection with the eNB and informs this to the UE-NAS layer, the UE-NAS layer may be switched from the EMM-CONNECTED mode with the light connection to the EMM-CONNECTED mode and perform an operation of transmitting the UL NAS message in the same manner as previously.

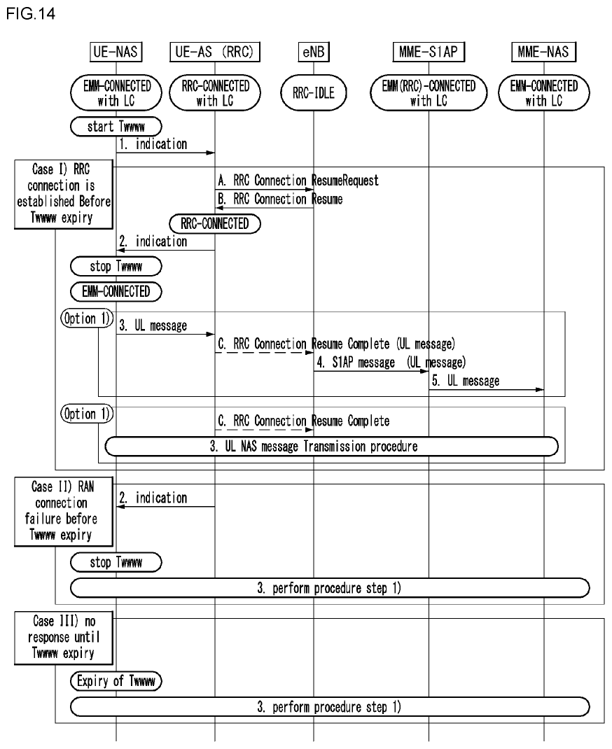

FIG. 14 is a diagram illustrating a method for transmitting and receiving UL NAS message according to an embodiment of the present invention.

Step 1) In the case that a UL NAS message transmission is required, the UE-NAS layer forwards an indication that the UL NAS message transmission is required to the UE-AS layer (e.g., RRC layer of the UE). For example, the indication may be an indication for requesting (UL) NAS message delivery.

In addition, since the UE-NAS layer has a UL NAS message to forward to the MME, the indication may be interpreted as an indication for requesting to start an operation for establishing an RRC connection between the eNB (e.g., start of RRC connection establishment procedure, etc.).

And, the UE-NAS layer starts timer Twwww to identify that the RRC connection is successfully established.

A. The UE-NAS layer may include the EMM layer and the ESM layer. That is, in this embodiment, the UL NAS message may include all UL EMM NAS messages and UL ESM messages.

As an example of the EMM procedure, the UL NAS message may be an UPLINK NAS TRANSPORT message. As an example of the ESM procedure, the UL NAS message may be PDN CONNECTIVITY REQUEST message.

Hereinafter, several cases that may occur thereafter are distinguished, and the operation is described for each case.

Case 1) A Case That the RRC Connection is Successfully Established Before Twwww Timer Expires

Step A) The UE-AS (RRC) layer transmits the RRC Connection Resume Request message to the eNB to establish the RRC connection.

Step B) In the case that the eNB accepts the RRC Connection Resume Request, the eNB transmits the RRC Connection Resume message to the UE-AS layer. After completing this step, the eNB and/or the UE may be switched to the RRC-CONNECTED state.

Step 2) The UE-AS layer that receives the RRC Connection Resume message forwards the indication for RRC connection establishment informing that the RRC connection is successfully established to the UE-NAS layer. The UE-NAS layer that receives this is switched to the EMM-CONNECTED mode and stops timer Twwww.

Later, the operation of transmitting a UE NAS message is performed. At this time, the method of transmission may be distinguished into two options below according to the method of transmission.

The two options may be applied with being divided as follows. In the case of the initial NAS message transmitted in the existing EMM-IDLE mode, option 1 may be applied, and in the case of the NAS message transmitted in the EMM-CONNECTED mode, option 2 may be applied.

Option 1)

Step 3) The UE-NAS layer transmits the UL NAS message to the UE-AS layer. The UE-AS layer that receives this may transmit the UL NAS message with being included in the fifth message (Msg5) (within the random-access procedure) (i.e., RRC Connection Resume Complete message) to the eNB.

For the operation above, in the case that the UE-AS layer receives the indication in step 1 above, when receiving the RRC Connection Resume message in step B, after waiting for the UL NAS message to be forwarded to the UE-NAS layer in step 3, the UE-AS layer may perform step C (i.e., transmit the UL NAS message to the eNB).

Step 4) The eNB that receives the UL NAS message transmits the received UL NAS message with being included in the SlAP message to the MME-S1AP layer.

Step 5) The MME-S1AP layer that receives it forwards the UL NAS message to the MME-NAS layer.

Option 2)

Step C) When the RRC Connection Resume message is received in step B above, step C may be performed immediately. That is, the RRC Connection Resume Complete message may be transmitted to the eNB.

Step 3) The UE-NAS layer performs the procedure for UL NAS message transmission. The order of performing step 3 may be performed without regard to the order of performing step C above. That is, step 3 may be performed before step C.

Case II) A Case That RAN Paging Retry is Failed Before Twwww Expiry

Step 2) In the case that the UE-AS layer fails to establish RRC connection, the UE-AS layer informs this to the UE-NAS layer. That is, the UE-AS layer may forward an indication for informing failure of RRC connection establishment to the UE-NAS layer.

At this time, the reason why establishment of RRC connection is failed may correspond to the case that it is barred in the corresponding cell or the case that the eNB rejects the RRC Connection Resume Request message. The indication may include a cause of the failure (e.g., failure of RRC connection establishment due to barring or failure of RRC connection establishment due to reject).

Step 3) The UE NAS layer that receives the indication may stop timer Twwww and determine that a transmission of DL NAS message is impossible. At this time, the UE-NAS layer may be switched to the EMM-IDLE mode or perform step 1 again in the EMM-CONNECTED mode with the light connection.

Case III) A Case That There is No Response Until Twwww Expires

In the case that the UE-NAS layer is unable to receive any response until timer Twwww expires (i.e., in the case that case I nor case II is not occurred), the UE-NAS layer determines that establishment of the RRC connection is impossible, and the UE-NAS layer is switched to the EMM-IDLE mode, or the UE-NAS layer may perform step 1 above again in the EMM-CONNECTED mode with the light connection.

Meanwhile, embodiment 1 and/or embodiment 2 above may be applied to all NAS message transmissions or selectively applied to some NAS message transmissions.

In the case of being selectively applied, embodiment 1 and/or embodiment 2 above may be applied only to the NAS message transmitted in the EMM-CONNECTED mode, and embodiment 1 and/or embodiment 2 above may not be applied to the initial NAS message which is transmitted in the EMM-IDLE mode. For example, in the case of the DL NAS message, embodiment 1 and/or embodiment 2 above may be applied to the MODIFY EPS BEARER CONTEXT REQUEST message, but embodiment 1 and/or embodiment 2 above may not be applied to the paging message.

Alternatively, embodiment 1 and/or embodiment 2 above may be applied to applied only to the ESM procedure, but embodiment 1 and/or embodiment 2 above may not be applied to the EMM procedure.

In addition, embodiment 1 above may be applied only to the case that the DL NAS message is a message that requires an uplink response.

Furthermore, embodiment 2 may also be applied to the NAS message that does not require a response. For example, embodiment 2 may be applied to the UPLINK NAS TRANSPORT message, the DOWNLINK NAS TRANSPORT message, the UPLINK GENERIC NAS TRANSPORT message, the DOWNLINK GENERIC NAS TRANSPORT, and the like.

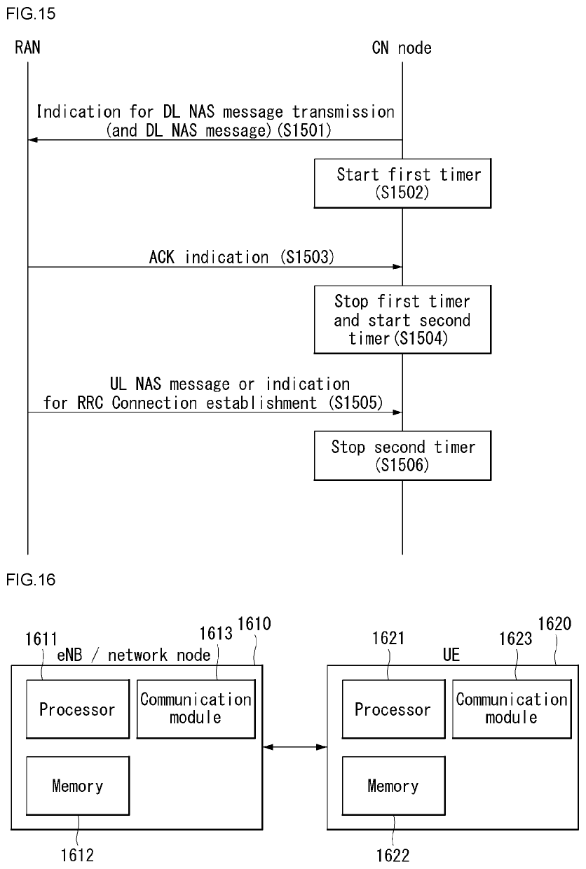

FIG. 15 is a diagram illustrating a method for transmitting and receiving NAS message according to an embodiment of the present invention.

In FIG. 15, a CN node may correspond to an MME or an AMF, and a RAN may correspond to an eNB or a gNB.

Referring to FIG. 15, the Core Network (CN) node transmits an indication for a DL NAS message transmission to the RAN (step, S1501).

Here, the CN node may transmit the DL NAS message together with the indication for DL NAS message transmission.

The indication for DL NAS message transmission may be interpreted as an indication for requesting an ACK response to whether the indication (and/or DL NAS message) for DL message transmission is successfully forwarded to the RAN or interpreted as an indication for requesting for the RAN to start an operation for establishing a connection with the UE (e.g., RAN paging start, etc.) since the CN node has a DL NAS message to forward to the UE.

The CN node start a first timer when transmitting the indication for DL NAS message transmission (and DL NAS message) (step, S1502).

Here, the first timer may be Txxxx of FIG. 10 or Tyyyy of FIG. 12 above.

The RAN that receives the indication for DL NAS message transmission (and DL NAS message) starts a transmission of paging to the UE when the UE is in the light connection (or RRC-INACTIVE) state. And, after starting paging transmission, the RAN transmits Acknowledgement (ACK) indication to the CN node in response to the indication for DL NAS message transmission (step, S1503).

The light connection (or RRC-INACTIVE) state of the UE may mean a state that a connection related to the UE is maintained between the RAN and the CN node, but the (RRC) connection between the UE and the RAN is related.

The ACK indication may be interpreted as an indication that the RAN successfully receives the indication for DL NAS message transmission (and/or DL NAS message) or may be interpreted as an indication for informing that the RAN starts an operation for establishing a connection with the UE (e.g., RAN paging start, etc.).

When receiving the ACK indication, the CN node stops the first timer and starts a second timer (step, S1504).

Here, the second timer may be Tabcd of FIG. 10 or Tzzzz of FIG. 12 above.

In the case that the CN node fails to receive the ACK indication from the RAN until the first timer expires, the CN node retransmits the indication for DL NAS message transmission (and DL NAS message) to the RAN.

Later, the RAN may receive the RRC Connection Resume Request message for requesting RRC Connection establishment from the UE in response to the paging. In addition, when the RAN accepts the RRC Connection establishment, in response to the RRC Connection Resume Request message, the RAN transmits the RRC Connection Resume message, and RRC connection between the UE and the RAN may be established.

As such, after the RRC connection is established with the UE, the RAN may transmit the RRC message including the DL NAS message to the UE. That is, in the case that the RAN receives the DL NAS message together with the indication for DL NAS message transmission in step S1501, the RAN buffers the received DL NAS message. When the RRC connection is established with the UE, the RAN may transmit the RRC message including the DL NAS message to the UE.

In addition, after the RRC connection is established with the UE, when the RAN receives the UL NAS message (i.e., receives RRC message including the UL NAS message), the RAN may transmit the UL NAS message (i.e., response to the DL NAS message) to the CN node (step, S1505). Alternatively, the RAN may transmit the indication for RRC Connection establishment with the UE to the CN node when the RRC connection is established with the UE (step, S1505).

When the CN node receives the UL NAS message from the RAN or receives the indication for RRC Connection establishment, the CN node stops the second timer (step, S1506).

At this time, after the CN node receives the indication for RRC Connection establishment from the RAN, the CN node may transmit the DL NAS message to the RAN. And, when the RAN receives the DL NAS message from the CN node, the RAN may transmit the RRC message including the DL NAS message to the UE.

Meanwhile, the paging transmission is failed, the RAN may transmit an indication or cause for informing failure of the paging transmission. The CN node that receives it may stop the second timer. And, the CN node may be switched to the IDLE mode or perform again from step S1501 (i.e., retransmit the indication for DL NAS message transmission (and DL NAS message) to the RAN).

In addition, in the case that the CN node fails to receive any response from the RAN until the second timer expires, the CN node may be switched to the IDLE mode or perform again from step S1501 (i.e., retransmit the indication for DL NAS message transmission (and DL NAS message) to the RAN).

General Apparatus to Which the Present Invention May Be Applied

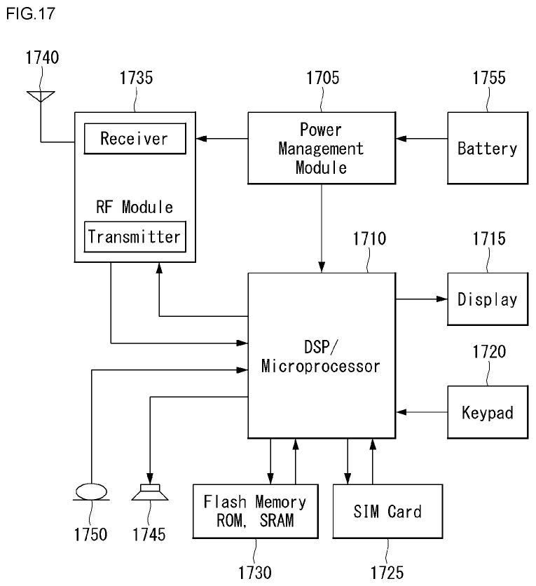

FIG. 16 illustrates a block diagram of a communication apparatus according to an embodiment of the present invention.

Referring to FIG. 16, a wireless communication system includes a network node 1610 and a plurality of User Equipments (UEs) 1620.

The network node 1610 includes a processor 1611, a memory 1612, and a communication module 1613. The processor 1611 implements the previously proposed functions, processes and/or methods proposed in FIG. 1 to FIG. 15. The layers of the wired/wireless interface protocol may be implemented by the processor 1611.

The memory 1612 is connected to the processor 1611 and stores various information for driving the processor 1611. The communication module 1613 is connected to the processor 1611 to transmit and/or receive a wired/wireless signal. An example of the network node 1610 may include a base station, an MME, an HSS, an SGW, a PGW, an AMF, an SMF, a UDF, and the like. Particularly, in the case that the network node 1610 is a base station, the communication module 1613 may include a radio frequency unit for transmitting/receiving a radio signal.

The UE 1620 includes a processor 1616, a memory 1622 and a communication module (or RF section). Processor 1621 implements the previously proposed functions, processes and/or methods proposed in FIG. 1 to FIG. 15. The layers of the wireless interface protocol may be implemented by the processor 1621. The memory 1622 is connected to the processor 1621 and stores various information for driving the processor 1621. The communication module 1623 is coupled to processor 1621 to transmit and/or receive wireless signals.

The memories 1612 and 1622 may be located inside or outside the processors 1611 and 1616 and may be coupled to the processors 1611 and 1621 by various well-known means. Also, the network node 1610 (in the case of a base station) and/or the UE 1620 may have a single antenna or multiple antennas.

FIG. 17 illustrates a block diagram of a wireless communication apparatus according to an embodiment of the present invention.

Particularly, in FIG. 17, the UE described above FIG. 16 will be exemplified in more detail.

Referring to FIG. 17, the UE includes a processor (or digital signal processor; DSP) 1710, RF module (RF unit) 1735, power management module 1705, antenna 1740, battery 1755, display 1715, keypad 1720, memory 1730, Subscriber Identification Module (SIM) card 1725 (which may be optional), speaker 1745 and microphone 1750. The UE may include a single antenna or multiple antennas.

The processor 1710 may be configured to implement the functions, procedures and/or methods proposed by the present invention as described in FIG. 1 to FIG. 15. Layers of a wireless interface protocol may be implemented by the processor 1710.

The memory 1730 is connected to the processor and stores information related to operations of the processor. The memory 1730 may be located inside or outside the processor and may be connected to the processors 1710 through various well-known means.

A user enters instructional information, such as a telephone number, for example, by pushing (or touching) the buttons of a keypad 1720 or by voice activation using the microphone 1750. The processor 1710 receives and processes the instructional information to perform the appropriate function, such as to dial the telephone number. Operational data may be retrieved from the SIM card 1725 or the memory module 1730 to perform the function. Furthermore, the processor 1710 may display the instructional and operational information on the display 1715 for the user's reference and convenience.

The RF module 1735 is connected to the processor 1710, transmits and/or receives an RF signal. The processor 1710 issues instructional information to the RF module 1735, to initiate communication, for example, transmits radio signals comprising voice communication data. The RF module 1735 includes a receiver and a transmitter to receive and transmit radio signals. An antenna 1740 facilitates the transmission and reception of radio signals. Upon receiving radio signals, the RF module 1735 may forward and convert the signals to baseband frequency for processing by the processor 1710. The processed signals would be transformed into audible or readable information outputted via the speaker 1745.

In the embodiments described above, the components and the features of the present invention are combined in a predetermined form. Each component or feature should be considered as an option unless otherwise expressly stated. Each component or feature may be implemented not to be associated with other components or features. Further, the embodiment of the present invention may be configured by associating some components and/or features. The order of the operations described in the embodiments of the present invention may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present invention may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the embodiment of the present invention may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present invention may be embodied in other specific forms without departing from essential characteristics of the present invention. Accordingly, the aforementioned detailed description should not be construed as restrictive in all terms and should be exemplarily considered. The scope of the present invention should be determined by rational construing of the appended claims and all modifications within an equivalent scope of the present invention are included in the scope of the present invention.

The present invention applied to a 3GPP LTE/LTE-A system is primarily described as an example but may be applied to various wireless communication systems in addition to the 3GPP LTE/LTE-A system, particularly, 5 generation (5G) system.

What is claimed is:

1. A method for transmitting a Non-Access Stratum (NAS) message to a User Equipment (UE) in a wireless communication system, comprising:
receiving, by a base station, an indication for a transmission of a downlink NAS message from a Core Network (CN) node;
initiating, by the base station, a transmission of paging to the UE, when a connection related to the UE is maintained between the base station and the CN node, but the UE is in a state in which a connection is related from the base station; and
transmitting, by the base station, an Acknowledgement (ACK) indication to the CN node in response to the indication after the paging transmission is initiated.

2. The method for transmitting a NAS message of claim 1, further comprising:
receiving, by the base station, an RRC Connection Resume Request message for requesting Radio Resource Control (RRC) connection establishment from the UE in response to the paging; and
transmitting, by the base station, an RRC Connection Resume Request message in response to the RRC Connection Resume Request message, when the base station accepts the RRC connection establishment.

3. The method for transmitting a NAS message of claim 2, further comprising:
transmitting, by the base station, an RRC message including the downlink NAS message to the UE after the RRC connection establishment is completed, when the base station receives the downlink NAS message together with the indication.

4. The method for transmitting a NAS message of claim 3, further comprising:
transmitting, by the base station, the downlink NAS message to the CN node, when the base station receives the RRC message including an uplink NAS message, which is a response to the downlink NAS message from the UE.

5. The method for transmitting a NAS message of claim 2, further comprising:
transmitting, by the base station, an indication for the RRC connection establishment to the CN node, when the RRC connection establishment is completed; and
transmitting, by the base station, an RRC message including the downlink NAS message to the UE, when the base station receives the downlink NAS message from the CN node.

6. The method for transmitting a NAS message of claim 1, further comprising:
transmitting, by the base station, an indication or cause for informing a failure of the paging transmission to the CN node, when the paging transmission is failed.

7. A method for transmitting a Non-Access Stratum (NAS) message to a User Equipment (UE) in a wireless communication system, comprising:
transmitting, by a Core Network (CN) node, an indication for a transmission of a downlink NAS message to a base station, and staring a first timer when transmitting the indication; and
stopping, by the CN node, the first timer when the CN node receives an Acknowledgement (ACK) indication from the base station in response to the indication,
wherein a connection related to the UE is maintained between the base station and the CN node, but the UE is in a state in which a connection is related from the base station.

8. The method for transmitting a NAS message of claim 7, wherein the downlink NAS message is transmitted together with the indication or transmitted after receiving an indication for a Radio Resource Control (RRC) connection from the base station.

9. The method for transmitting a NAS message of claim 7, further comprising:
starting a second timer, when the ACK indication is received.

10. The method for transmitting a NAS message of claim 9, further comprising:
stopping the second timer when an uplink NAS message is received from the UE, which is a response to the downlink NAS message.

11. The method for transmitting a NAS message of claim 9, further comprising:
stopping the second timer, when an indication for a Radio Resource Control (RRC) connection establishment is received from the base station.

12. The method for transmitting a NAS message of claim 9, further comprising:
stopping the second timer, when an indication or cause for informing a failure of the paging transmission.

13. The method for transmitting a NAS message of claim 12, further comprising:
switching, by the CN node, to an IDLE mode or retransmitting the indication to the base station.

14. The method for transmitting a NAS message of claim 9, further comprising:
switching, by the CN node, to an IDLE mode or retransmitting the downlink NAS message and the indication to the base station, when any response is received from the base station until the second timer expires.
